(19) United States
(12) Patent Application Publication
(10) Pub. No.: US 2026/0222705 A1
(43) Pub. Date: Jul. 30, 2026

(54) IMAGING ELEMENT AND ELECTRONIC DEVICE

(71) Applicant: SONY SEMICONDUCTOR SOLUTIONS CORPORATION, KANAGAWA (JP)

(72) Inventor: Luonghung ASAKURA, KANAGAWA (JP)

(21) Appl. No.: 19/145,441

(22) PCT Filed: Nov. 16, 2023
(86) PCT No.: PCT/JP2023/041175

§ 371 Date: Jul. 2, 2025

(30) Foreign Application Priority Data
Jan. 10, 2023 (JP) 2023-001451

(51) Int. Cl. H04N 25/77; H04N 25/709

(52) U.S. Cl. CPC H04N 25/77; H04N 25/709

(57) ABSTRACT

To suppress variations in charge injection due to a switching operation at the time of sampling and holding.

An imaging element of the present technology includes a pixel array unit and a sample-and-hold circuit provided corresponding to a pixel column of the pixel array unit. The sample-and-hold circuit includes: first and second capacitive elements; first and second sampling transistors connected in series to the first and second capacitive elements; first and second write transistors that are connected between an input terminal and the first and second sampling transistors, and write a reset signal and a data signal input from the input terminal to the first and second capacitive elements; first and second read transistors that read the reset signal and the data signal written to the first and second capacitive elements; and a reset transistor connected between an output terminal and a node of a predetermined reference potential.

### TECHNICAL FIELD

The present technology relates to an imaging element. Specifically, the present technology relates to an imaging element including a sample-and-hold circuit that samples and holds a pixel signal output from a pixel, and an electronic device including the imaging element.

### BACKGROUND ART

An imaging element such as a complementary metal oxide semiconductor (CMOS) image sensor is mounted with an analog-digital conversion unit that digitizes an analog pixel signal read from a pixel. The analog-digital conversion unit mounted on the imaging element has a so-called column-parallel type analog-digital conversion unit configuration including a plurality of analog-digital conversion circuits arranged corresponding to pixel columns.

In analog-digital conversion processing, by performing pipeline processing (pipelining) on a signal read operation from a pixel and an analog-digital conversion operation, a substantial pixel signal read operation including the analog-digital conversion processing can be speeded up, and thus a frame rate can be improved. In order to achieve the pipeline processing on the signal read operation and the analog-digital conversion operation, it is necessary to dispose a sample-and-hold circuit before the analog-digital conversion circuit.

A pixel signal read from the pixel includes a reset signal (so-called P-phase signal) which is at a reset level and is output from the pixel at the time of reset, and a data signal (so-called D-phase signal) which is at a signal level and is output from the pixel at the time of photoelectric conversion. As a sample-and-hold circuit that samples and holds the pixel signal including the reset signal and the data signal, there is a sample-and-hold circuit that separately includes a path for sampling and holding the reset signal and a path for sampling and holding the data signal (see, for example, Patent Document 1).

### CITATION LIST

### Patent Document

Patent Document 1: Japanese Patent Application Laid-Open No. 2009-253930

### SUMMARY OF THE INVENTION

### Problems to be Solved by the Invention

In the conventional technique described above, since the path for sampling and holding the reset signal and the path for sampling and holding the data signal are separately provided, variations in charge injection due to a switching operation on each path cause variations in a sampling error. The variations in the sampling error appear as a vertical streak on a captured image, which causes deterioration in image quality.

The present technology has been made in view of such a situation, and an object thereof is to suppress variations in charge injection due to a switching operation at the time of sampling and holding in a sample-and-hold circuit.

### Solutions to Problems

The present technology has been made to solve the above-described problems, and a first aspect of the present technology is an imaging element including: a pixel array unit in which a plurality of pixels each including a photoelectric conversion unit is arranged in a matrix; and a sample-and-hold circuit that is provided corresponding to a pixel column of the above-described pixel array unit and samples and holds a pixel signal including a reset signal and a data signal output from the above-described pixels through a signal line, in which the above-described sample-and-hold circuit includes: a first capacitive element; a first sampling transistor connected in series to the above-described first capacitive element; a first write transistor that is connected between an input terminal configured to receive the above-described reset signal and the above-described first sampling transistor, and writes the above-described reset signal input from the above-described input terminal into the above-described first capacitive element, through the above-described first sampling transistor; a first read transistor that is connected between the above-described first sampling transistor and an output terminal, and reads the above-described reset signal written in the above-described first capacitive element, through the above-described first sampling transistor; a second capacitive element; a second sampling transistor connected in series to the above-described second capacitive element; a second write transistor that is connected between an input terminal configured to receive the above-described data signal and the above-described second sampling transistor, and writes the above-described data signal input from the above-described input terminal into the above-described second capacitive element, through the above-described second sampling transistor; a second read transistor that is connected between the above-described second sampling transistor and the above-described output terminal, and reads the above-described data signal written in the above-described second capacitive element, through the above-described second sampling transistor; and a reset transistor that is connected between the above-described output terminal and a node of a predetermined reference potential. As a result, an effect is provided that variations in charge injection due to a switching operation are suppressed at the time of sampling and holding in a sample-and-hold circuit.

Furthermore, in this first aspect, the above-described first sampling transistor and the above-described second sampling transistor each may include a transistor having a relatively small size. As a result, an effect is provided that a sampling error can be further suppressed.

Furthermore, in this first aspect, each of the above-described first write transistor, the above-described first read transistor, the above-described second write transistor, the above-described second read transistor, and the above-described reset transistor may include a transistor having a relatively large size. As a result, an effect is provided that a higher-speed operation can be achieved.

Furthermore, in this first aspect, the imaging element may be configured such that the above-described first write transistor and the above-described first sampling transistor are brought into an ON state and the above-described reset signal is written into the above-described first capacitive element, then the above-described first sampling transistor is brought into an OFF state, then the above-described first read transistor and the above-described reset transistor are brought into an ON state and a signal read path is initialized, and then the above-described first sampling transistor is brought into an ON state and the above-described reset signal written in the above-described first capacitive element is read through the above-described signal read path, and thereafter, the above-described second write transistor and the above-described second sampling transistor are brought into an ON state and the above-described data signal is written into the above-described second capacitive element, then the above-described second sampling transistor is brought into an OFF state, then the above-described second read transistor and the above-described reset transistor are brought into an ON state and the above-described signal read path is initialized, and then the above-described second sampling transistor is brought into an ON state and the above-described data signal written in the above-described second capacitive element is read through the above-described signal read path. As a result, an effect is provided that variations in charge injection due to a switching operation at the time of sampling and holding are suppressed.

Furthermore, in this first aspect, the imaging element may be configured such that, in a state in which the above-described first sampling transistor and the above-described second sampling transistor are always in an ON state and the above-described reset transistor is always in an OFF state, the above-described first write transistor is brought into an ON state and the above-described reset signal is written into the above-described first capacitive element, and then the above-described first read transistor is brought into an ON state and the above-described reset signal written in the above-described first capacitive element is read, and thereafter, the above-described second write transistor is brought into an ON state and the above-described data signal is written into the above-described second capacitive element, and then the above-described second read transistor is brought into an ON state and the above-described data signal written in the above-described second capacitive element is read. As a result, it is possible to minimize time overhead between the write operation and the read operation of the reset signal and data signal, and an effect is provided that a speed of the read operation on the pixel signal can be further increased.

Furthermore, in this first aspect, an amplifier disposed between the above-described signal line and the above-described sample-and-hold circuit may be further included. As a result, an effect is provided that input conversion of noise after the sample-and-hold circuit can be reduced.

Furthermore, in this first aspect, the imaging element may be configured such that a low-error drive mode and a high-speed drive mode are provided, in the above-described low-error drive mode, the above-described first write transistor and the above-described first sampling transistor are brought into an ON state and the above-described reset signal is written into the above-described first capacitive element, then the above-described first sampling transistor is brought into an OFF state, then the above-described first read transistor and the above-described reset transistor are brought into an ON state and a signal read path is initialized, and then the above-described first sampling transistor is brought into an ON state and the above-described reset signal written in the above-described first capacitive element is read through the above-described signal read path, and thereafter, the above-described second write transistor and the above-described second sampling transistor are brought into an ON state and the above-described data signal is written into the above-described second capacitive element, then the above-described second sampling transistor is brought into an OFF state, then the above-described second read transistor and the above-described reset transistor are brought into an ON state and the above-described signal read path is initialized, and then the above-described second sampling transistor is brought into an ON state and the above-described data signal written in the above-described second capacitive element is read through the above-described signal read path, and in the above-described high-speed drive mode, in a state in which the above-described first sampling transistor and the above-described second sampling transistor are always in an ON state and the above-described reset transistor is always in an OFF state, the above-described first write transistor is brought into an ON state and the above-described reset signal is written into the above-described first capacitive element, and then the above-described first read transistor is brought into an ON state and the above-described reset signal written in the above-described first capacitive element is read, and thereafter, the above-described second write transistor is brought into an ON state and the above-described data signal is written into the above-described second capacitive element, and then the above-described second read transistor is brought into an ON state and the above-described data signal written into the above-described second capacitive element is read. As a result, an effect is provided that, even in the sample-and-hold circuit having the same circuit configuration, it is possible to select whether to emphasize a characteristic or an operation speed by using a driving method of the sample-and-hold circuit.

Furthermore, in this first aspect, the imaging element may be configured such that the above-described sample-and-hold circuit includes a power supply path switching unit that connects a terminal on a power supply side of each of the above-described first capacitive element and the above-described second capacitive element to different power supply paths electrically separated, at the time of signal writing into the above-described first capacitive element and the above-described second capacitive element and at the time of signal reading from the above-described first capacitive element and the above-described second capacitive element. As a result, an effect is provided that crosstalk that fluctuates signals read in parallel can be reduced.

Furthermore, in this first aspect, the imaging element may be configured such that the above-described sample-and-hold circuit has a wiring structure in which a wiring line between the above-described first capacitive element and the above-described first sampling transistor and a wiring line between the above-described second capacitive element and the above-described second sampling transistor are shielded by a wiring line between the above-described first capacitive element and the above-described power supply path switching unit and a wiring line between the above-described second capacitive element and the above-described power supply path switching unit. As a result, an effect is provided that resistance to noise and crosstalk can be enhanced.

Furthermore, in this first aspect, the imaging element may be configured such that, in the above-described wiring structure, a wiring length of a wiring line between the above-described first capacitive element and the above-described first sampling transistor is equal to a wiring length of a wiring line between the above-described second capacitive element and the above-described second sampling transistor. As a result, an effect is provided that a sampling error and disturbance of the reset signal and data signal can be aligned and removed by CDS processing executed in the analog-digital conversion unit in a subsequent stage.

Furthermore, a second aspect of the present technology is an electronic device including an imaging element, the imaging element including: a pixel array unit in which a plurality of pixels each including a photoelectric conversion unit is arranged in a matrix; and a sample-and-hold circuit that is provided corresponding to a pixel column of the above-described pixel array unit and samples and holds a pixel signal including a reset signal and a data signal output from the above-described pixels through a signal line, in which the above-described sample-and-hold circuit includes: a first capacitive element; a first sampling transistor connected in series to the above-described first capacitive element; a first write transistor that is connected between an input terminal configured to receive the above-described reset signal and the above-described first sampling transistor, and writes the above-described reset signal input from the above-described input terminal into the above-described first capacitive element, through the above-described first sampling transistor; a first read transistor that is connected between the above-described first sampling transistor and an output terminal, and reads the above-described reset signal written in the above-described first capacitive element, through the above-described first sampling transistor; a second capacitive element; a second sampling transistor connected in series to the above-described second capacitive element; a second write transistor that is connected between an input terminal configured to receive the above-described data signal and the above-described second sampling transistor, and writes the above-described data signal input from the above-described input terminal into the above-described second capacitive element, through the above-described second sampling transistor; a second read transistor that is connected between the above-described second sampling transistor and the above-described output terminal, and reads the above-described data signal written in the above-described second capacitive element, through the above-described second sampling transistor; and a reset transistor that is connected between the above-described output terminal and a node of a predetermined reference potential. As a result, variations in charge injection due to the switching operation at the time of sampling and holding are reduced, so that fixed pattern noise of the pixel column can be suppressed, leading to an effect that a captured image with high image quality can be obtained.

### BRIEF DESCRIPTION OF DRAWINGS

FIG. 1 is a system configuration diagram illustrating a configuration example of an imaging element according to an embodiment of the present technology.

FIG. 2 is a circuit diagram illustrating a circuit example of a pixel (pixel circuit) of the imaging element according to the embodiment of the present technology.

FIG. 3 is a perspective view for explaining an outline of a semiconductor chip structure of the imaging element according to the embodiment of the present technology.

FIG. 4 is a block diagram illustrating a basic configuration example of an analog-digital conversion unit of the imaging element according to the embodiment of the present technology.

FIG. 5 is a diagram for explaining a sample-and-hold circuit according to Reference Example 1.

FIG. 6 is a diagram for explaining a mechanism in which variations in charge injection cause a sampling error.

FIG. 7 is a diagram for explaining a sample-and-hold circuit according to Reference Example 2.

FIG. 8 is a timing chart for explaining a circuit operation example of the sample-and-hold circuit according to Reference Example 2.

FIG. 9 is a circuit diagram illustrating a circuit configuration example of a sample-and-hold circuit according to the embodiment of the present technology.

FIG. 10 is a timing chart illustrating Circuit operation example 1 of the sample-and-hold circuit according to the embodiment of the present technology.

FIG. 11 is a diagram for explaining consideration of a sampling error.

FIG. 12 is a timing chart illustrating Circuit operation example 2 of the sample-and-hold circuit according to the embodiment of the present technology.

FIG. 13 is a block diagram illustrating an arrangement example of the sample-and-hold circuit according to the embodiment of the present technology.

FIG. 14 is a circuit diagram for explaining a drive mode of the sample-and-hold circuit according to the embodiment of the present technology.

FIG. 15 is a diagram for explaining a wiring structure of the sample-and-hold circuit according to the embodiment of the present technology.

FIG. 16 is a block diagram illustrating a configuration example of an imaging device which is an example of an electronic device to which the present technology is applied.

FIG. 17 is a diagram illustrating an example of fields to which the embodiment of the present technology is applied.

FIG. 18 is a block diagram illustrating an example of schematic configuration of a vehicle control system.

FIG. 19 is an explanatory diagram illustrating an example of an installation position of an imaging unit.

### MODE FOR CARRYING OUT THE INVENTION

A mode for carrying out the present technology (hereinafter, referred to as embodiment) will be described below. The description will be given in the following order.
1. Imaging element of present technology
1-1. Configuration example of imaging element
1-2. Circuit example of pixel
1-3. Semiconductor chip structure
1-4. Basic configuration example of analog-digital conversion unit
1-5. About pipeline processing
1-6. Reference example of sample-and-hold circuit
2. Sample-and-hold circuit according to embodiment of present technology
2-1. Example 1 (circuit configuration example of sample-and-hold circuit)
2-2. Example 2 (Circuit operation example 1 of sample-and-hold circuit)
2-3. Example 3 (Circuit operation example 2 of sample-and-hold circuit)
2-4. Example 4 (example of drive mode of imaging element)
2-5. Example 5 (example of arrangement of sample-and-hold circuit)
2-6. Example 6 (example of switching power supply path of low-potential-side power supply of capacitive element)
2-7. Example 7 (example of wiring structure of sample-and-hold circuit)
3. Modifications
4. Application example to electronic device
5. Usage example of imaging element
6. Configuration that can be adopted by present technology

### <Imaging Element of Present Technology>

One example of an imaging element of the present technology is a CMOS image sensor, which is a type of an X-Y address system imaging element. The CMOS image sensor is an imaging element fabricated by applying or partially using a CMOS process.

### [Configuration Example of Imaging Element]

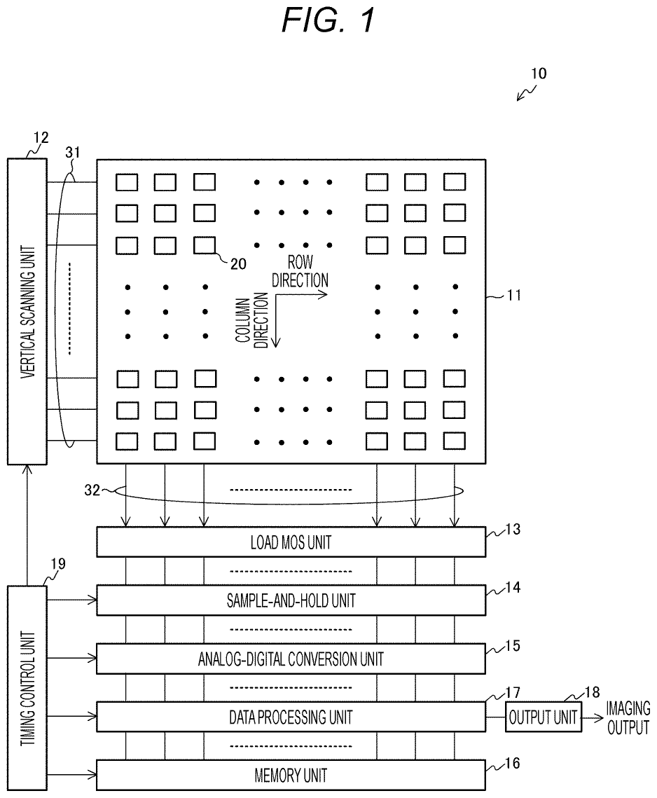

FIG. 1 is a block diagram illustrating a configuration example of an imaging element according to an embodiment of the present technology. An imaging element 10 according to the present embodiment has a configuration including a pixel array unit 11 and a peripheral circuit unit of the pixel array unit 11. The peripheral circuit unit of the pixel array unit 11 includes, for example, a vertical scanning unit 12, a load MOS unit 13, a sample-and-hold unit 14, an analog-digital conversion unit 15, a memory unit 16, a data processing unit 17, an output unit 18, a timing control unit 19, and the like.

The pixel array unit 11 has pixels (pixel circuits) 20 which are two-dimensionally arranged in a row direction and a column direction, that is, in a matrix. Each of the pixels 20 includes a photoelectric conversion unit (photoelectric conversion element). Here, the row direction refers to a direction in which pixels 20 in a pixel row are arrayed, and the column direction refers to a direction in which the pixels 20 in a pixel column are arrayed. The pixel 20 performs photoelectric conversion to generate and accumulate photoelectric charges corresponding to an amount of incident light. In the example illustrated in FIG. 1, the pixel array of the pixel array unit 11 is a pixel array of m rows and n columns (m and n are integers). That is, “m” represents the number of rows, and “n” represents the number of columns.

In the pixel array unit 11, a pixel control line 31 is wired for every pixel row, for the pixel array of m rows and n columns. Furthermore, a signal line 32 is wired for every pixel 20.

When reading a signal from the pixel 20, the pixel control line 31 transmits a drive signal output from the vertical scanning unit 12 in units of pixel rows. In FIG. 1, the pixel control line 31 is illustrated as one wiring line, but the number thereof is not limited to one. One end of the pixel control line 31 is connected to an output end corresponding to each row of the vertical scanning unit 12. The signal line 32 transmits a signal read from the pixel 20 to the sample-and-hold unit 14.

Hereinafter, a description is given to each component of the peripheral circuit unit of the pixel array unit 11, that is, the vertical scanning unit 12, the load MOS unit 13, the sample-and-hold unit 14, the analog-digital conversion unit 15, the memory unit 16, the data processing unit 17, the output unit 18, and the timing control unit 19.

The vertical scanning unit 12 includes a shift register, an address decoder, and the like, and controls scanning of the pixel row and an address of the pixel row on the basis of a timing control signal supplied from the timing control unit 19 at the time of selecting each pixel 20 of the pixel array unit 11. Although a specific configuration of the vertical scanning unit 12 is not illustrated, the vertical scanning unit 12 generally includes two scanning systems of a read scanning system and a sweep scanning system.

The read scanning system selectively scans in order the pixels 20 in the pixel array unit 11 row by row in order to read a pixel signal from each pixel 20. The pixel signal read from the pixel 20 is an analog signal. The sweep scanning system performs sweep scanning on a read row subjected to read scanning by the read scanning system earlier than the read scanning by an amount of time corresponding to a shutter speed.

When the sweep scanning is performed by this sweep scanning system, an unnecessary charge is swept from the photoelectric conversion unit of the pixels 20 in the read row. As a result, the photoelectric conversion unit is reset. Then, unnecessary charges are swept out (reset) by the sweep scanning system, whereby so-called electronic shutter operation is performed. Here, the electronic shutter operation refers to an operation of discharging photocharges of the photoelectric conversion unit and newly starting exposure (starting accumulation of photocharges).

The signals read by the read operation by the read scanning system corresponds to the amount of light received after the immediately preceding read operation or electronic shutter operation. Then, a period from a read timing by the immediately preceding read operation or a sweep timing by the electronic shutter operation to a read timing by the current read operation is an exposure period of a photocharge in the pixels 20.

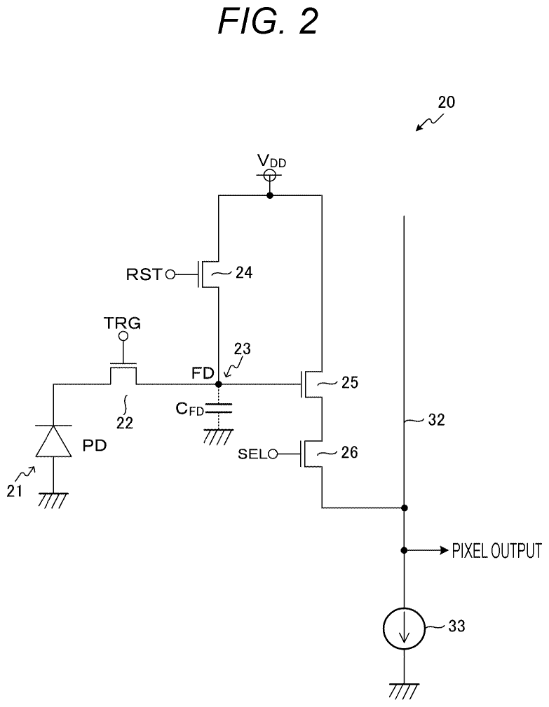

The load MOS unit 13 includes a plurality of current sources 33 (see FIG. 2) each including a MOS transistor connected to each of the signal lines 32 for each pixel column, and supplies a bias current to each pixel 20 of a pixel row selectively scanned by the vertical scanning unit 12, through each of the signal lines 32.

The sample-and-hold unit 14 samples and holds the pixel signal supplied from the pixel 20 through the signal line 32. The present technology is applied to the sample-and-hold unit 14. Details of the sample-and-hold unit 14 to which the present technology is applied will be described later.

The analog-digital (A/D) conversion unit 15 includes a plurality of analog-digital conversion circuits provided corresponding to the signal line 32, and converts, into a digital signal, an analog pixel signal output from the sample-and-hold unit 14 for each pixel column. The analog-digital conversion circuit can be a well-known analog-digital conversion circuit. Specifically, as the analog-digital conversion circuit, a single-slope analog-digital conversion circuit, a successive approximation analog-digital conversion circuit, or a delta-sigma (ΔΣ) analog-digital conversion circuit can be exemplified. However, the analog-digital conversion circuit is not limited to these types.

The memory unit 16 stores an analog-digital conversion result in the analog-digital conversion unit 15 under processing by the data processing unit 17.

The data processing unit 17 is a digital signal processing unit that processes a digital signal output from the analog-digital conversion unit 15, and performs a process of writing and reading the analog-digital conversion result to and from the memory unit 16, and performs various processes on the analog-digital conversion result.

The output unit 18 derives a signal processed by the data processing unit 17 as an imaging output.

The timing control unit 19 generates various timing signals, clock signals, control signals, and the like on the basis of a synchronization signal provided from the outside. Then, the timing control unit 19 performs drive control of the vertical scanning unit 12, the sample-and-hold unit 14, the analog-digital conversion unit 15, the data processing unit 17, and the like on the basis of the generated signals.

### [One Circuit Example of Pixel]

FIG. 2 is a circuit diagram illustrating a circuit example of the pixel (pixel circuit) 20 of the imaging element 10 according to the embodiment of the present technology. Each pixel 20 of the pixel array unit 11 includes a photoelectric conversion unit 21, a charge transfer unit 22, a charge-voltage conversion unit 23, a charge resetting unit 24, a signal amplification unit 25, and a pixel selection unit 26. A predetermined voltage is supplied from a power supply (pixel power supply) of the pixel 20 to the charge resetting unit 24 and the signal amplification unit 25.

Here, as the charge transfer unit 22, the charge resetting unit 24, the signal amplification unit 25, and the pixel selection unit 26, for example, an N-channel MOS field effect transistor (hereinafter, referred to as a MOS transistor) can be used. However, a combination of conductivity types of the four MOS transistors 22, 24, 25, and 26 exemplified here is merely an example, and the combination is not limited thereto.

For the pixel 20, as the pixel control line 31 described above, a plurality of pixel control lines is wired in common to the individual pixels 20 of the same pixel row. The plurality of pixel control lines is connected to an output end corresponding to each pixel row of the vertical scanning unit 12, in units of pixel rows. The vertical scanning unit 12 appropriately outputs a transfer signal TRG, a reset signal RST, and a selection signal SEL to the plurality of pixel control lines.

Note that the constant current source 33 is connected to one end of the signal line 32 wired for every pixel column of the pixel array unit 11.

The photoelectric conversion units 21 are PN-junction photodiodes (PDs). The photodiode has an anode electrode connected to a low potential side power supply (for example, ground), and generates and accumulates charges according to an amount of incident light.

The charge transfer unit 22 transfers the charges accumulated in the photoelectric conversion unit 21 to the charge-voltage conversion unit 23, in accordance with the transfer signal TRG provided from the vertical scanning unit 12. Specifically, the transfer signal TRG that is active at a high level is supplied from the vertical scanning unit 12 to a gate electrode of a transistor constituting the charge transfer unit 22. Then, the transistor constituting the charge transfer unit 22 is brought into a conductive state, and transfers the charges accumulated in the photoelectric conversion unit 21 to the charge-voltage conversion unit 23.

The charge-voltage conversion unit 23 is capacitance of a floating diffusion (FD) region formed between a drain region of the transistor constituting the charge transfer unit 22 and a source region of the transistor constituting the charge resetting unit 24. The charge-voltage conversion unit 23 converts the charges transferred from the photoelectric conversion unit 21 by the charge transfer unit 22 into a voltage.

The charge resetting unit 24 resets the charges accumulated in the charge-voltage conversion unit 23 in accordance with the reset signal RST provided from the vertical scanning unit 12. Specifically, the reset signal RST that is active at a high level is provided from the vertical scanning unit 12 to the gate electrode of the transistor constituting the charge resetting unit 24. Then, the transistor constituting the charge resetting unit 24 becomes conductive, and resets the charge accumulated in the charge-voltage conversion unit 23.

The signal amplification unit 25 amplifies the voltage converted by the charge-voltage conversion unit 23, and outputs a pixel signal at a level corresponding to the charges accumulated in the charge-voltage conversion unit 23. A gate electrode of a transistor constituting the signal amplification unit 25 is connected to the charge-voltage conversion unit 23, and a drain electrode is connected to the node of a power supply voltage V_{DD}. Then, the transistor constituting the signal amplification unit 25 serves as an input unit of a readout circuit that reads out charges obtained by photoelectric conversion in the photoelectric conversion unit 21, that is, a source follower circuit. That is, in the transistor constituting the signal amplification unit 25, the source electrode is connected to the signal line 32 via the pixel selection unit 26, thereby constituting a source follower circuit with the constant current source 33 connected to one end of the signal line 32.

The pixel selection unit 26 selects any pixel 20 in the pixel array unit 11 under selective scanning by the vertical scanning unit 12. The transistor constituting the pixel selection unit 26 is connected between the source electrode of the transistor constituting the signal amplification unit 25 and the signal line 32, and the selection signal SEL in which a high level is active is supplied from the vertical scanning unit 12 to the gate electrode thereof. Then, when the selection signal SEL becomes a high level, the transistor constituting the pixel selection unit 26 is brought into a conductive state. As a result, the pixel 20 enters a selected state. When the pixel 20 enters the selected state, a signal output from the signal amplification unit 25 is read out to the load MOS unit 13 via the signal line 32.

The pixel 20 of the circuit configuration example described above sequentially outputs a reset signal P (so-called P-phase signal) which is at a reset level at the time of resetting the charge-voltage conversion unit 23 with the charge resetting unit 24, and a data signal D (so-called D-phase signal) which is at a signal level corresponding to a charge based on the photoelectric conversion in the photoelectric conversion unit 21. That is, the pixel signal output from the pixel 20 includes the reset signal P at the time of resetting and the data signal D at the time of photoelectric conversion in the photoelectric conversion unit 21.

### [Semiconductor Chip Structure]

As the semiconductor chip structure of the imaging element 10 according to the present embodiment having the above-described configuration, a flat-type semiconductor chip structure and a stacked-type semiconductor chip structure can be exemplified. Furthermore, regarding a pixel structure, when a substrate surface on a side on which a wiring layer is formed is defined as a front surface (front), a back-illuminated pixel structure can be employed that receives light emitted from a back surface side opposite to the front surface, or a front-illuminated pixel structure can be employed that receives light emitted from a front surface side.

Hereinafter, an outline of a flat-type semiconductor chip structure and a stacked-type semiconductor chip structure will be described.

### (Flat-Type Semiconductor Chip Structure)

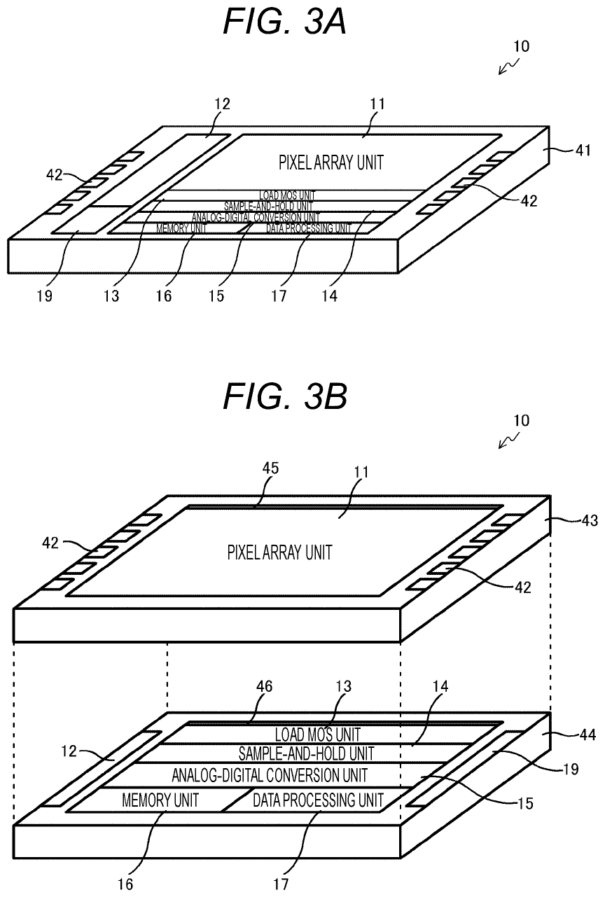

In FIG. 3, a is a perspective view schematically illustrating a flat-type chip structure of the imaging element 10. As illustrated in a of FIG. 3, the flat-type semiconductor chip structure has a structure in which each component of the peripheral circuit unit of the pixel array unit 11 is formed on a semiconductor substrate 41 same as the pixel array unit 11 in which the pixels 20 are arranged in a matrix. Specifically, the vertical scanning unit 12, the load MOS unit 13, the sample-and-hold unit 14, the analog-digital conversion unit 15, the memory unit 16, the data processing unit 17, the timing control unit 19, and the like are formed on the semiconductor substrate 41 same as the pixel array unit 11. Pads 42 for external connection and power supply are provided, for example, at both left and right end portions of the semiconductor substrate 41 in the first layer.

### (Stacked-Type Semiconductor Chip Structure)

In FIG. 3, b is an exploded perspective view schematically illustrating a stacked-type semiconductor chip structure of the imaging element 10. As illustrated in b of FIG. 3, the stacked-type semiconductor chip structure has a structure in which at least two semiconductor substrates of a first layer of a semiconductor substrate 43 and a second layer of a semiconductor substrate 44 are stacked.

In this stacked-type semiconductor chip structure, the semiconductor substrate 43 of the first layer is a pixel chip in which the pixel array unit 11 is formed in which the pixels 20 each including a photoelectric conversion unit (for example, a photodiode) are two-dimensionally arranged in a matrix. Pads 42 for external connection and power supply are provided, for example, at both left and right end portions of the semiconductor substrate 43 in the first layer.

The semiconductor substrate 44 of the second layer is a circuit chip in which the peripheral circuit unit of the pixel array unit 11, that is, the vertical scanning unit 12, the load MOS unit 13, the sample-and-hold unit 14, the analog-digital conversion unit 15, the memory unit 16, the data processing unit 17, the timing control unit 19, and the like are formed. Note that an arrangement of the vertical scanning unit 12, the load MOS unit 13, the sample-and-hold unit 14, the analog-digital conversion unit 15, the memory unit 16, the data processing unit 17, the timing control unit 19, and the like is an example, and is not limited to this arrangement example.

The pixel array unit 11 on the semiconductor substrate 43 of the first layer and the peripheral circuit unit on the semiconductor substrate 44 of the second layer are electrically connected via a connection portion (not illustrated) including a metal-metal junction including a Cu—Cu connection, a through silicon via (TSV), a microbump, and the like.

According to the stacked-type semiconductor chip structure described above, a process suitable for manufacturing the pixel array unit 11 can be applied to the first-layer semiconductor substrate 43, and a process suitable for manufacturing the circuit portion can be applied to the second-layer semiconductor substrate 44. Thus, the process can be optimized during manufacture of the imaging element 10. In particular, an advanced process can be applied when the circuit portion is fabricated.

### [Basic Configuration Example of Analog-Digital Conversion Unit]

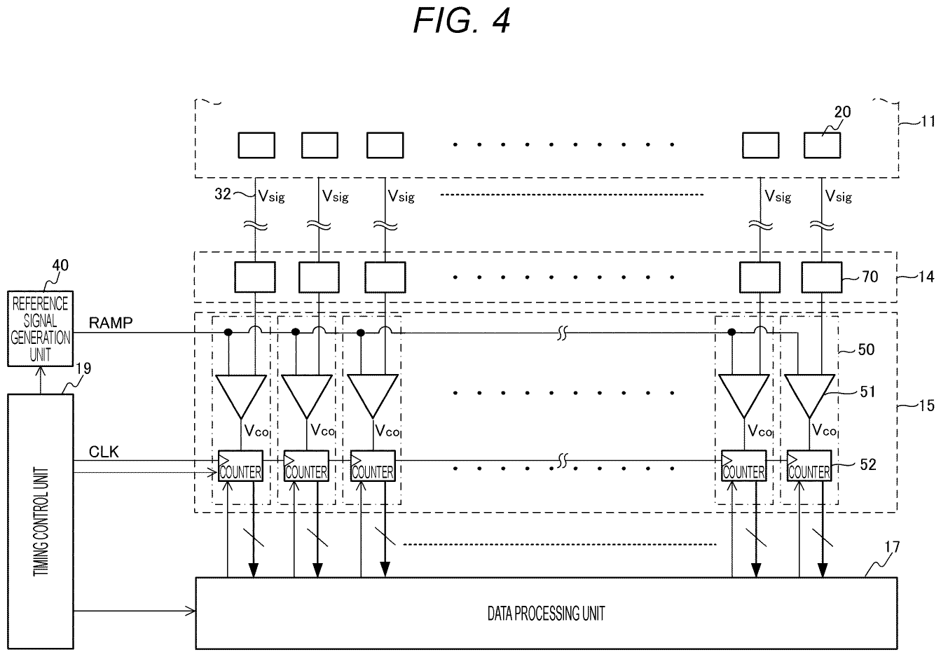

Next, a basic configuration example of the analog-digital conversion unit 15 will be described. FIG. 4 is a block diagram illustrating a basic configuration example of the analog-digital conversion unit 15 of the imaging element 10 according to the embodiment of the present technology. FIG. 4 also illustrates a peripheral circuit unit of the analog-digital conversion unit 15.

The analog-digital conversion unit 15 acquires an analog pixel signal supplied from each pixel 20 of the pixel array unit 11 through the signal line 32 on the basis of a timing control signal supplied from the timing control unit 19, and sequentially converts the analog pixel signal into a digital pixel signal.

The analog-digital conversion unit 15 includes a plurality of analog-digital conversion circuits 50 provided corresponding to the individual pixels 20 of the pixel array unit 11. In the imaging element 10 according to the embodiment of the present technology, for example, a so-called single-slope analog-digital conversion circuit, which is an example of a reference signal comparison analog-digital conversion circuit, is used as the analog-digital conversion circuit 50.

In the analog-digital conversion unit 15 using the single-slope analog-digital conversion circuit, a reference signal of an inclined waveform that linearly changes (for example, monotonically decreases) with time with a predetermined inclination is used, that is, a reference signal RAMP of a ramp wave is used as a reference signal at the time of analog-digital conversion. The reference signal RAMP of the ramp wave is generated in a reference signal generation unit 40 on the basis of a timing control signal supplied from the timing control unit 19. The reference signal generation unit 40 can be configured using, for example, a digital-analog conversion circuit.

The analog-digital conversion circuit 50 includes a comparator 51 and a column counter 52, and is provided for each pixel column of the pixel array unit 11.

The comparator 51 uses, as a comparison input, an analog pixel signal Vsig supplied from each pixel 20 of the pixel array unit 11 through the signal line 32, and uses the reference signal RAMP of the ramp wave generated by the reference signal generation unit 40, as a reference input to compare both signals. Then, for example, at the timing when the reference signal RAMP of the ramp wave exceeds a voltage value of the analog pixel signal Vsig, a signal (comparison result) Vco notifying that the reference signal RAMP exceeds the voltage value of the analog pixel signal Vsig is output. As a result, the comparator 51 outputs a pulse signal having a pulse width corresponding to a signal level of the analog pixel signal Vsig, specifically, corresponding to magnitude of a signal level, as the comparison result Vco.

To the column counter 52, a clock signal CLK is supplied from the timing control unit 19 at the same timing as a supply start timing of the reference signal RAMP of the ramp wave to the comparator 51. The column counter 52 performs a counting operation in synchronization with the clock signal CLK, thereby measuring a period of a pulse width of an output pulse of the comparator 51, that is, a period from a start of the comparison operation to an end of the comparison operation. A count result (count value) of the column counter 52 is supplied to the data processing unit 17 as a digital value obtained by digitizing the analog pixel signal Vsig.

As the column counter 52, for example, an up/down counter can be used. In the column counter 52 including an up/down counter, a down (DOWN) count or an up (UP) count is performed in synchronization with the clock signal CLK. Specifically, for example, for the reset signal P which is output from the pixel 20 and is at a reset level at the time of resetting the charge-voltage conversion unit 23 and the data signal D which is output from the pixel 20 and is at a signal level based on photoelectric conversion, the reset signal P is down-counted, while the data signal D is up-counted.

A difference between the data signal D and the reset signal P can be obtained by the down count/up count operation. As a result, the analog-digital conversion unit 15 performs correlated double sampling (CDS) processing in addition to the analog-digital conversion processing. Here, the “CDS processing” is a process of removing fixed pattern noise unique to the pixel, such as reset noise of the pixel 20 and threshold variations of the signal amplification unit 25, by obtaining a difference between the data signal D which is at a signal level based on photoelectric conversion and the reset signal P which is at a reset level at the time of resetting the charge-voltage conversion unit 23.

As described above, the analog-digital conversion unit 15 including the single-slope analog-digital conversion circuit 50 compares the analog pixel signal Vsig output from the pixel 20 with the reference signal RAMP of the ramp wave generated by the reference signal generation unit 40. Then, a digital value can be obtained from time information from the start of the comparison to a timing at which the magnitude relationship between the analog pixel signal Vsig and the reference signal RAMP of the ramp wave changes (that is, a timing at which an output of the comparator 51 is inverted).

[about Pipeline Processing]

In the imaging element 10 according to the present embodiment described above, that is, the imaging element 10 on which the column-parallel type analog-digital conversion unit 15 is mounted, pipeline processing on the signal read operation from the pixel 20 and the analog-digital conversion operation can be achieved by providing the sample-and-hold unit 14 at a preceding stage of the analog-digital conversion unit 15. As illustrated in FIG. 4, the sample-and-hold unit 14 includes a plurality of sample-and-hold circuits 70 provided corresponding to the individual pixel columns of the pixel array unit 11.

By the pipeline processing (pipelining) on the signal read operation and the analog-digital conversion operation, the substantial pixel signal read operation including the analog-digital conversion processing can be speeded up, so that a frame rate can be improved. Conversely, in a case of not improving the frame rate (that is, in a case where the frame rate is set equal to a conventional frame rate), it is possible to increase a blanking period in which the signal reading and the analog-digital conversion are not performed, and thus, it is possible to reduce power consumption of the imaging element 10.

### [Reference Example of Sample-And-Hold Circuit]

### (Reference Example 1)

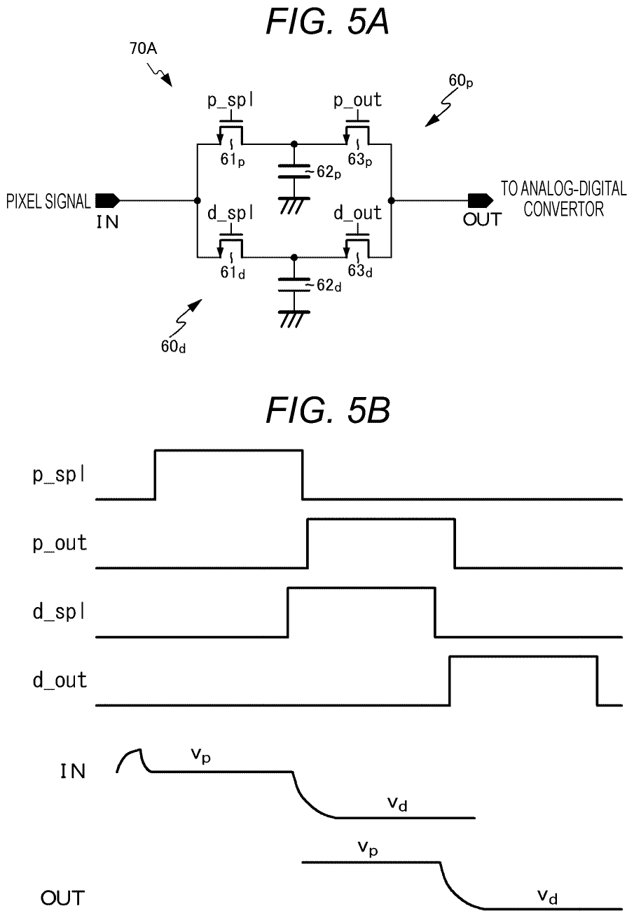

Here, a basic sample-and-hold circuit will be described as a sample-and-hold circuit according to Reference Example 1. FIG. 5 is a diagram for explaining a sample-and-hold circuit 70A according to Reference Example 1.

As illustrated in a of FIG. 5, the sample-and-hold circuit 70A according to Reference Example 1 has a circuit configuration including a P-phase path 60ₚ for sampling and holding a reset signal P (P-phase signal) which is at a reset level when the charge-voltage conversion unit 23 is reset, and a D-phase path 60_{d} for sampling and holding a data signal D (D-phase signal) which is at a signal level based on photoelectric conversion.

The P-phase path 60ₚ includes a sampling transistor 61ₚ that samples the reset signal P, a capacitive element 62ₚ that holds the reset signal P sampled by the sampling transistor 61ₚ, and an output transistor 63ₚ. The sampling transistor 61ₚ samples the reset signal P on the basis of a control signal p_spl, and causes the capacitive element 62ₚ to hold the reset signal P. The output transistor 63ₚ outputs the reset signal P held in the capacitive element 62ₚ in response to a control signal p_out.

The D-phase path 60_{d} includes a sampling transistor 61_{d} that samples data signal D, a capacitive element 62_{d} that holds data signal D sampled by sampling transistor 61_{d}, and an output transistor 63_{d}. The sampling transistor 61_{d} samples the data signal D on the basis of a control signal d_spl, and causes the capacitive element 62_{d} to hold the data signal D. The output transistor 63_{d} outputs the data signal D held in the capacitive element 62_{d} in response to a control signal d_out.

A timing chart in b of FIG. 5 illustrates a timing relationship between the control signal p_spl, the control signal p_out, the control signal d_spl, the control signal d_out, an input signal IN (reset signal P/data signal D), and an output signal OUT.

As described above, the sample-and-hold circuit 70A according to Reference Example 1 has a configuration in which the P-phase path 60ₚ for sampling and holding the reset signal P and the D-phase path 60_{d} for sampling and holding the data signal D are separately provided. Therefore, channel charges of the sampling transistor 61ₚ and the output transistor 63ₚ may vary due to manufacturing variations of a threshold voltage Vₜₕ, a gate area, and the like of the transistor in each of the paths 60ₚ and 60_{d}. The variations in charge injection cause a sampling error, that is, a fixed pattern noise of the pixel column, and are visually recognized as a vertical streak on a captured image.

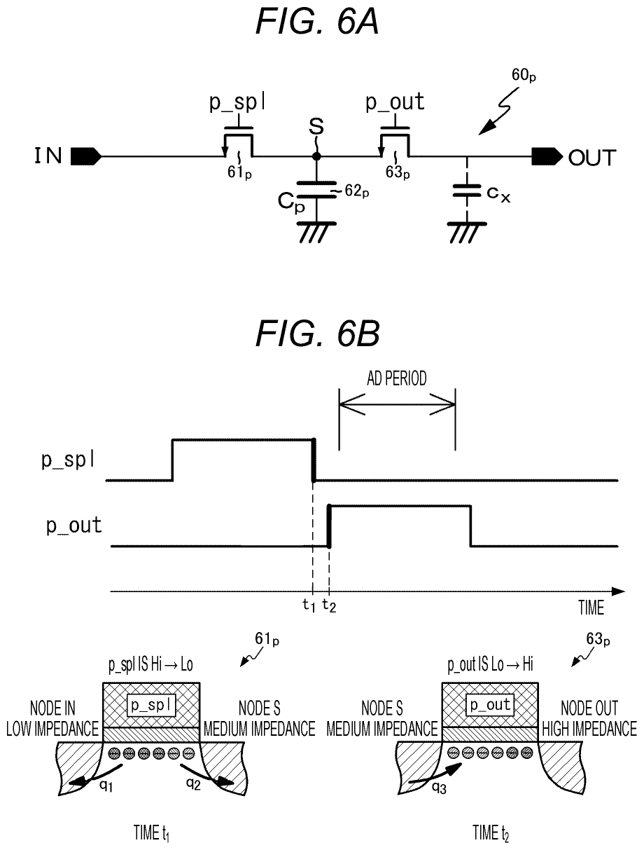

A mechanism in which variations in charge injection cause a sampling error as described above will be described with reference to FIG. 6. In a of FIG. 6, for convenience of explanation, the P-phase path 60ₚ in a of FIG. 5 is taken out and illustrated, but things similar to those in the P-phase path 60ₚ also occur in the D-phase path 60_{d}.

In the P-phase path 60ₚ, when a capacitance value of the capacitive element 62ₚ is Cₚ and a capacitance value of a parasitic capacitance on the output side of the output transistor 63ₚ is cₓ, Cₚ>>cₓ is generally satisfied. Therefore, an impedance (α1/Cₚ) of a node S is lower than an impedance (α1/cₓ) of a node OUT.

As illustrated in b of FIG. 6, in the sampling transistor 61ₚ, when the control signal p_spl transitions from a high level (Hi) to a low level (Lo) (time t₁), about a half q₂ of channel charges (q₁+q₂) enters the medium-impedance node S side, which causes a sampling error. Furthermore, in the output transistor 63ₚ, when the control signal p_out transitions from a low level to a high level (time t₂), most of channel charges q₃ are supplied from the medium-impedance node S, and some of the charges accumulated at the node S are consumed, which also causes a sampling error.

### Reference Example 2

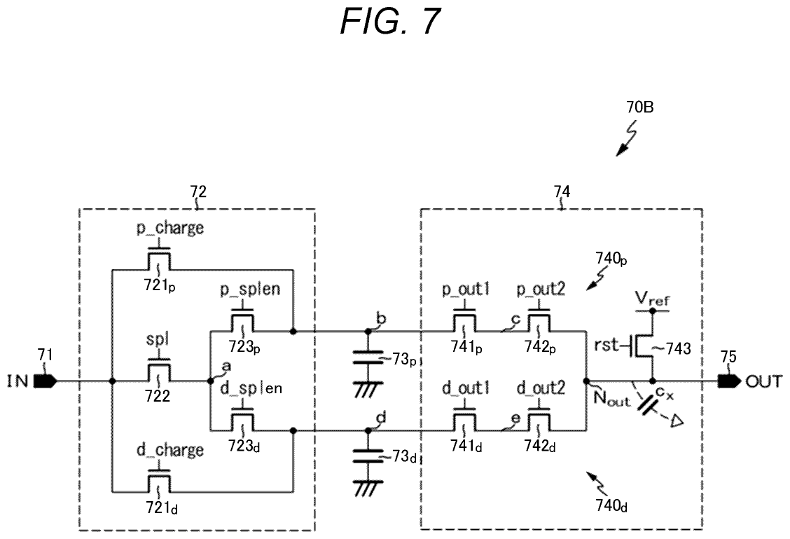

Next, a description is given to a sample-and-hold circuit intended to suppress variations in charge injection due to a switching operation at the time of sampling and holding, as a sample-and-hold circuit according to Reference Example 2. FIG. 7 is a diagram for explaining a sample-and-hold circuit 70B according to Reference Example 2.

As illustrated in FIG. 7, the sample-and-hold circuit 70B according to Reference Example 2 includes an input terminal 71, a write circuit 72, a first capacitive element 73ₚ, a second capacitive element 73_{d}, a read circuit 74, and an output terminal 75.

The input terminal 71 receives a reset signal P and a data signal D output from each pixel 20 of the pixel array unit 11. The reset signal P is a P-phase signal which is at a reset level when the charge-voltage conversion unit 23 is reset. The data signal D is a D-phase signal which is at a signal level based on photoelectric conversion in the photoelectric conversion unit 21.

The write circuit 72 samples and writes the reset signal P and the data signal D input from the input terminal 71. The first capacitive element 73ₚ is a capacitive element for P-phase, and holds the reset signal P written by the write circuit 72. The second capacitive element 73_{d} is a capacitive element for D-phase, and holds the data signal D written by the write circuit 72. The read circuit 74 reads the reset signal P held in the first capacitive element 73ₚ and the data signal D held in the second capacitive element 73_{d}. The output terminal 75 outputs the reset signal P and the data signal D read by the read circuit 74.

### Circuit Configuration Example of Write Circuit

The write circuit 72 includes a first charging transistor 721ₚ connected between the input terminal 71 and the first capacitive element 73ₚ, and a second charging transistor 721_{d} connected between the input terminal 71 and the second capacitive element 73_{d}. The write circuit 72 further includes a sampling transistor 722 that samples the reset signal P and the data signal D input from the input terminal 71, a first write transistor 723ₚ connected between the sampling transistor 722 and the first capacitive element 73ₚ, and a second write transistor 723_{d} connected between the sampling transistor 722 and the second capacitive element 73_{d}.

In the write circuit 72 having the above-described circuit configuration, the first charging transistor 721ₚ, the sampling transistor 722, the first write transistor 723ₚ, and the first capacitive element 73ₚ constitute a P-phase path for sampling and holding the reset signal P. Furthermore, the second charging transistor 721_{d}, the sampling transistor 722, the second write transistor 723_{d}, and the second capacitive element 73_{d} constitute a D-phase path for sampling and holding the data signal D. That is, in the write circuit 72, the sampling transistor 722 is shared by the P-phase path and the D-phase path.

By entering an ON state in response to a control signal p_charge, the first charging transistor 721ₚ charges the first capacitive element 73ₚ on the basis of the reset signal P input from the input terminal 71. By entering an ON state in response to a control signal d_charge, the second charging transistor 721_{d} charges the second capacitive element 73_{d} on the basis of the data signal D input from the input terminal 71. The sampling transistor 722 samples the reset signal P and the data signal D on the basis of a control signal spl. By entering an ON state in response to a control signal p_splen, the first write transistor 723ₚ writes the reset signal P sampled by the sampling transistor 722 into the first capacitive element 73ₚ, and causes the reset signal P to be held. By entering an ON state in response to a control signal d_splen, the second write transistor 723_{d} writes the data signal D sampled by the sampling transistor 722 into the second capacitive element 73_{d}, and causes the data signal D to be held.

### Circuit Operation Example of Write Circuit

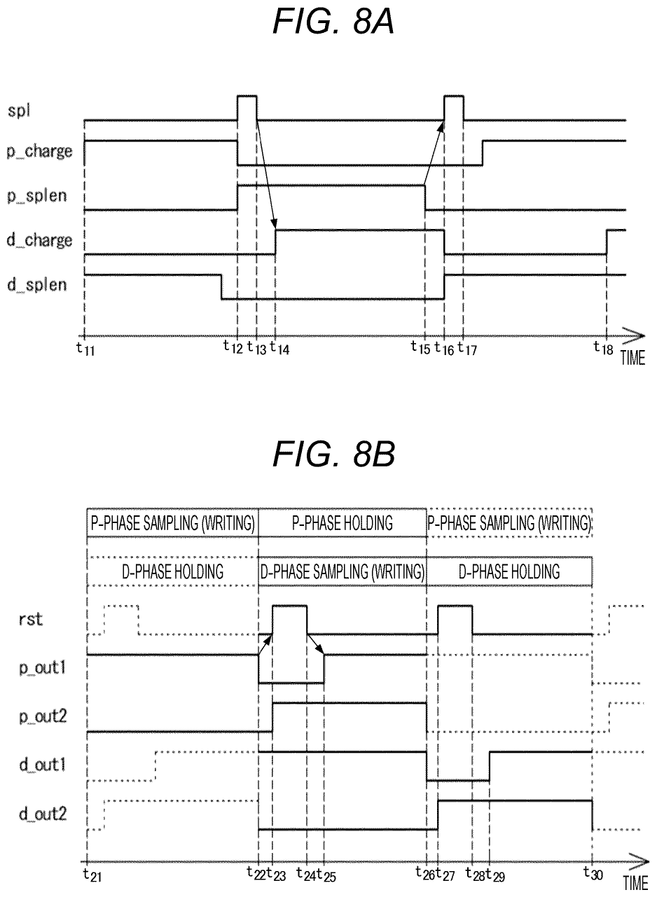

Next, a circuit operation example of the write circuit 72 will be described using a timing chart in a of FIG. 8.

When the control signal p_charge transitions from a low level to a high level at time t₁₁ which is when the reset signal P is input from the input terminal 71, the first charging transistor 721ₚ is brought into an ON state, and causes the first capacitive element 73ₚ to be charged on the basis of the reset signal P input from the input terminal 71.

Next, at time t₁₂, the control signal p_charge transitions from a high level to a low level, so that the first charging transistor 721ₚ is brought into an OFF state. At the same time, the control signal spl and the control signal p_splen transition from a low level to a high level, so that the sampling transistor 722 and the first write transistor 723ₚ are brought into an ON state. As a result, the reset signal P sampled by the sampling transistor 722 is held in the first capacitive element 73ₚ through the first write transistor 723ₚ.

Next, at time t₁₃, the control signal spl transitions from a high level to a low level, and the sampling transistor 722 is brought into an OFF state, so that a charge amount held in the first capacitive element 73ₚ is determined. From time t₁₃ to time t₁₅, the first capacitive element 73ₚ is in a holding state. During this period from time t₁₃ to time t₁₅, a potential level corresponding to the charge amount held in the first capacitive element 73ₚ can be read by the read circuit 74 at a subsequent stage.

An operation similar to that of the P-phase path is performed for the D-phase path. That is, when the control signal d_charge transitions from a low level to a high level at time t₁₄ which is when the data signal D is input from the input terminal 71, the second charging transistor 721_{d} is brought into an ON state, and causes the second capacitive element 73_{d} to be charged on the basis of the data signal D input from the input terminal 71.

Next, at time t₁₆, the control signal d_charge transitions from a high level to a low level, so that the second charging transistor 721_{d} is brought into an OFF state. At the same time, the control signal spl and the control signal d_splen transition from a low level to a high level, so that the sampling transistor 722 and the second write transistor 723_{d} are brought into an ON state. As a result, the data signal D sampled by the sampling transistor 722 is held in the second capacitive element 73_{d} through the second write transistor 723_{d}.

Next, at time t₁₇, the control signal spl transitions from a high level to a low level, and the sampling transistor 722 is brought into an OFF state, so that a charge amount held in the second capacitive element 73_{d} is determined. From time t₁₇ to time t₁₈, the second capacitive element 73_{d} is in a holding state. During this period from time t₁₇ to time t₁₈, a potential level corresponding to the charge amount held in the second capacitive element 73_{d} can be read by the read circuit 74 at a subsequent stage.

As described above, in the write circuit 72, the first capacitive element 73ₚ is charged to a signal level input from the input terminal 71 via the first charging transistor 721ₚ, under the control of the control signal p_charge in the period from time t₁₁ to time t₁₂. As a result, in a short period from time t₁₂ to time t₁₃, the path is switched to the path by the sampling transistor 722 and the first write transistor 723ₚ at high speed, and a sample-and-hold voltage of the first capacitive element 73ₚ can be determined (the D-phase path is also the same as the P-phase path).

### Circuit Configuration Example of Read Circuit

The read circuit 74 includes a first output circuit 740ₚ connected between the first capacitive element 73ₚ and the output terminal 75, a second output circuit 740_{d} connected between the second capacitive element 73_{d} and the output terminal 75, and a reset transistor 743 that resets a potential of each output node Nₒᵤₜ of the first and second output circuits 740ₚ and 740_{d}. Each output node Nₒᵤₜ of the first and second output circuits 740ₚ and 740_{d} is electrically connected to the output terminal 75.

The first output circuit 740ₚ is a P-phase output path, and includes a pre-stage output transistor 741ₚ and a post-stage output transistor 742ₚ connected in series between the first capacitive element 73ₚ and the output node Nₒᵤₜ. The second output circuit 740_{d} is a D-phase output path, and includes a pre-stage output transistor 741_{d} and a post-stage output transistor 742_{d} connected in series between the second capacitive element 73_{d} and the output node Nₒᵤₜ. The reset transistor 743 is connected between a node of a predetermined reference potential V_{ref} and the output node Nₒᵤₜ connected to the output terminal 75.

In the first output circuit 740ₚ, the pre-stage output transistor 741ₚ performs an ON/OFF operation in response to a control signal p_out1, and the post-stage output transistor 742ₚ performs an ON/OFF operation in response to a control signal p_out2. In the second output circuit 740_{d}, the pre-stage output transistor 741_{d} performs an ON/OFF operation in response to a control signal d_out1, and the post-stage output transistor 742_{d} performs an ON/OFF operation in response to a control signal d_out2. The reset transistor 743 performs ON/OFF operation in response to a control signal rst.

The read circuit 74 controls to output a potential level corresponding to a charge amount held in the first capacitive element 73ₚ having a capacitance value Cₚ or the second capacitive element 73_{d} having a capacitance value C_{d}, to the column-parallel type analog-digital conversion unit 15 at a subsequent stage through the output terminal 75. The parasitic capacitance cₓ exists at the output node Nₒᵤₜ connected to the output terminal 75. In a case where reading from the first capacitive element 73ₚ or the second capacitive element 73_{d} is performed in a state where a potential history of previous reading remains in the parasitic capacitance cₓ, a problem occurs in which a read error depending on the read history occurs.

Therefore, the read circuit 74 adopts a configuration in which the reset transistor 743 for resetting the potential of the output node Nₒᵤₜ is provided, and the potential of the output node Nₒᵤₜ is reset to the predetermined reference potential V_{ref} immediately before reading from the first capacitive element 73ₚ or the second capacitive element 73_{d} is performed. With this configuration, the above-described problem can be prevented in advance.

### Circuit Operation Example of Read Circuit

Next, a circuit operation example of the read circuit 74 will be described with reference to a timing chart in b of FIG. 8.

During a period from time t₂₁ to time t₂₂, sampling of P phase (reset signal P) is performed in the P phase path including the first capacitive element 73ₚ having the capacitance value Cₚ. During this sampling period, the control signal p_out1 of the pre-stage output transistor 741ₚ of the first output circuit 740ₚ is in a high level state, and the pre-stage output transistor 741ₚ is brought into an ON state.

Next, during a period from time t₂₂ to time t₂₆, reading of a potential level corresponding to a charge amount held in the first capacitive element 73ₚ is performed. Specifically, first, the control signal p_out1 transitions from a high level to a low level at time t₂₂, so that the pre-stage output transistor 741ₚ is brought into an OFF state.

Next, at time t₂₃, the control signal p_out2 and the control signal rst transition from a low level to a high level, so that both the post-stage output transistor 742ₚ and the reset transistor 743 are brought into an ON state. As a result, the potential of the output node Nₒᵤₜ of the read circuit 74 is reset to the predetermined reference potential V_{ref}. Then, at time t₂₄, the control signal rst transitions from a low level to a high level, and the reset transistor 743 is brought into an OFF state, whereby the reset operation of the output node Nₒᵤₜ is completed.

Next, at time t₂₅, the control signal p_out1 transitions from a low level to a high level, and the pre-stage output transistor 741ₚ is brought into an ON state again, so that a potential level corresponding to a charge amount held in the first capacitive element 73ₚ is read out to the output terminal 75 through the pre-stage output transistor 741ₚ and the post-stage output transistor 742ₚ. Then, at time t₂₆, the control signal p_out2 transitions from a high level to a low level, and the post-stage output transistor 742ₚ is brought into an OFF state, whereby the P-phase (reset signal P) read operation is completed.

An operation similar to that of the P-phase path is performed for the D-phase path. That is, during a period from time t₂₂ to time t₂₆, sampling of the D-phase (data signal D) is performed in the D-phase path including the second capacitive element 73_{d} having the capacitance value C_{d}. During this sampling period, the control signal d_out1 of the pre-stage output transistor 741_{d} of the second output circuit 740_{d} is in a high level state, and the pre-stage output transistor 741_{d} is brought into an ON state.

Next, during a period from time t₂₆ to time t₃₀, reading of a potential level corresponding to a charge amount held in the second capacitive element 73_{d} is performed. Specifically, first, the control signal d_out1 transitions from a high level to a low level at time t₂₆, so that the pre-stage output transistor 741_{d} is brought into an OFF state.

Next, at time t₂₇, the control signal d_out2 and the control signal rst transition from a low level to a high level, so that both the post-stage output transistor 742_{d} and the reset transistor 743 are brought into an ON state. As a result, the potential of the output node Nₒᵤₜ of the read circuit 74 is reset to the predetermined reference potential V_{ref}. Then, at time t₂₈, the control signal rst transitions from a low level to a high level, and the reset transistor 743 is brought into an OFF state, whereby reset of the output node Nₒᵤₜ is completed.

Next, at time t₂₉, the control signal d_out1 transitions from a low level to a high level, and the pre-stage output transistor 741_{d} is brought into an ON state again, so that a potential level corresponding to a charge amount held in the second capacitive element 73_{d} is read out to the output terminal 75 through the pre-stage output transistor 741_{d} and the post-stage output transistor 742_{d}. Then, at time t₃₀, the control signal d_out2 transitions from a high level to a low level, and the post-stage output transistor 742_{d} is brought into an OFF state, whereby the D-phase (data signal D) read operation is completed.

In the sample-and-hold circuit 70B according to Reference Example 2 described above, for example, in the write circuit 72, a sampling error due to feed through and charge injection of the sampling transistor 722 common to the P-phase and the D-phase occurs in common in the first capacitive element 73ₚ and the second capacitive element 73_{d}. Therefore, a sampling error that occurs in common in the first capacitive element 73ₚ and the second capacitive element 73_{d} can be removed by, for example, the CDS processing executed in the column-parallel type analog-digital conversion unit 15. That is, the sample-and-hold circuit 70B according to Reference Example 2 can solve the problem of the sample-and-hold circuit 70A according to Reference Example 1, that is, the problem of a sampling error due to variations in charge injection.

However, the sample-and-hold circuit 70B according to Reference Example 2 has a circuit configuration that requires five transistors for each of the write circuit 72 and the read circuit 74, that is, a total of ten transistors, and the number of transistors constituting the sample-and-hold circuit 70B is very large. Furthermore, there is a problem that timing overhead is large because there are many before-after constraints of a transition timing of the control signal at four locations (arrows (→) in a and b in FIG. 8).

### <Sample-and-Hold Circuit According to Embodiment of Present Technology>

A sample-and-hold circuit according to the embodiment of the present technology has a simpler circuit configuration (simpler than the sample-and-hold circuit 70B according to Reference Example 2) to suppress a sampling error due to variations in charge injection in the sample-and-hold circuit 70A according to Reference Example 1.

### Example 1

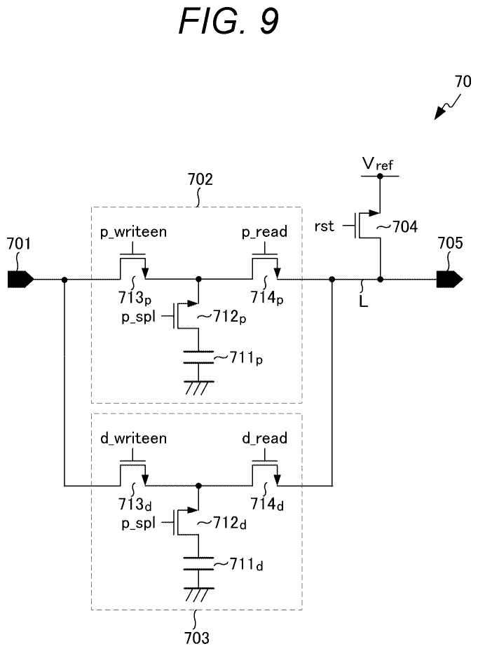

Example 1 is an example of a circuit configuration of the sample-and-hold circuit according to the embodiment of the present technology. FIG. 9 is a circuit diagram illustrating a circuit configuration example of the sample-and-hold circuit according to the embodiment of the present technology.

As illustrated in FIG. 9, a sample-and-hold circuit 70 according to the embodiment of the present technology includes an input terminal 701, a P-phase circuit 702, a D-phase circuit 703, a reset transistor 704, and an output terminal 705.

To the input terminal 701, a pixel signal output from the pixel 20 through the signal line 32 is provided. The pixel signal includes a reset signal P which is at a reset level at the time of resetting the charge-voltage conversion unit 23, and the data signal D which is at a signal level based on photoelectric conversion. The input terminal 701 receives a reset signal P and a data signal D provided from the signal line 32.

The P-phase circuit 702 includes a first capacitive element 711ₚ, a first sampling transistor 712ₚ, a first write transistor 713ₚ, and a first read transistor 714ₚ.

In the P-phase circuit 702, one end of the first capacitive element 711ₚ is connected to a power supply (for example, ground). The first sampling transistor 712ₚ is connected in series to the first capacitive element 711ₚ. The first write transistor 713ₚ is connected between the input terminal 701 and the first sampling transistor 712ₚ, and is brought into an ON state in response to a control signal p_writeen provided to a gate electrode, to write the reset signal P input from the input terminal 701 into the first capacitive element 711ₚ through the first sampling transistor 712ₚ. The first read transistor 714ₚ is connected between the first sampling transistor 712ₚ and the output terminal 705, and is brought into an ON state in response to a control signal p_read provided to a gate electrode, to read the reset signal P written in the first capacitive element 711ₚ through the first sampling transistor 712ₚ.

The D-phase circuit 703 includes a second capacitive element 711_{d}, a second sampling transistor 712_{d}, a second write transistor 713_{d}, and a second read transistor 714_{d}.

In the D-phase circuit 703, one end of the second capacitive element 711_{d} is connected to a power supply (for example, ground). The second sampling transistor 712_{d} is connected in series to the second capacitive element 711_{d}. The second write transistor 713_{d} is connected between the input terminal 701 and the second sampling transistor 712_{d}, and is brought into an ON state in response to a control signal d_writeen provided to a gate electrode, to write the data signal D input from the input terminal 701 into the second capacitive element 711_{d} through the second sampling transistor 712_{d}. The second read transistor 714_{d} is connected between the second sampling transistor 712_{d} and the output terminal 705, and is brought into an ON state in response to a control signal d_read provided to a gate electrode, to read the data signal D written in the second capacitive element 711_{d} through the second sampling transistor 712_{d}.

The reset transistor 704 is connected between the output terminal 705 and a node of a predetermined reference potential V_{ref}. A path between the output terminal 705 and the first read transistor 714ₚ and the second read transistor 714_{d} is a signal read path L for reading the reset signal P from the first capacitive element 711ₚ and the data signal D from the second capacitive element 711_{d}. The reset transistor 704 is brought into an ON state in response to a control signal rst, to reset a potential of the signal read path L to the predetermined reference potential V_{ref}.

The sample-and-hold circuit 70 according to the embodiment of the present technology having the above-described configuration uses, for example, NMOS transistors as the first and second sampling transistors 712ₚ and 712_{d}, the first and second write transistors 713ₚ and 713_{d}, the first and second read transistors 714ₚ and 714_{d}, and the reset transistor 704.

### Example 2

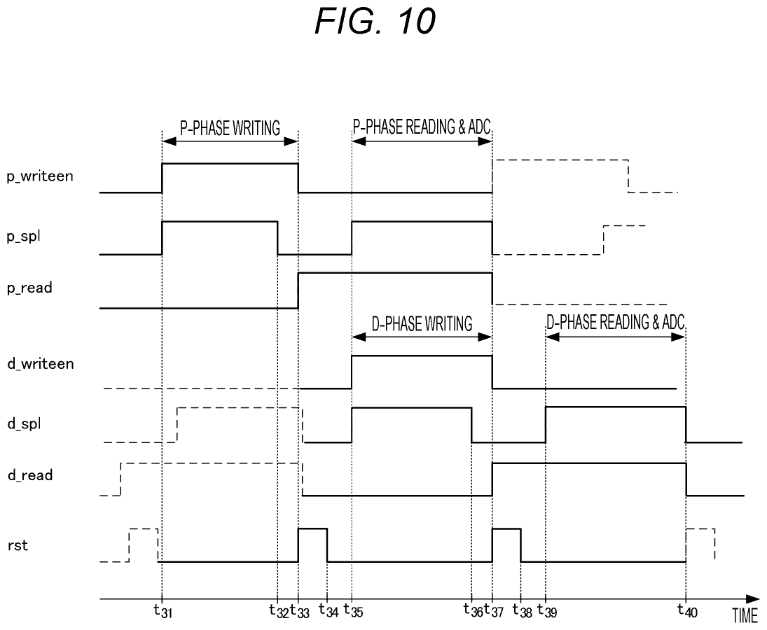

Example 2 is an example (part 1) of a circuit operation of the sample-and-hold circuit according to the embodiment of the present technology. FIG. 10 is a timing chart illustrating Circuit operation example 1 of the sample-and-hold circuit according to the embodiment of the present technology.

The timing chart of FIG. 10 illustrates a timing relationship between the control signal p_writeen, the control signal p_spl, and the control signal p_read for P-phase, the control signal d_writeen, the control signal d_spl, and the control signal d_read for D-phase, and the control signal rst. These control signals and the like are generated by the timing control unit 19 illustrated in FIG. 1.

At time t₃₁, the control signal p_writeen and the control signal p_spl transition from a low level to a high level, so that the first write transistor 713ₚ and the first sampling transistor 712ₚ are brought into an ON state, and a write operation of the reset signal P into the first capacitive element 711ₚ is performed.

At time t₃₂, the control signal p_spl transitions from a high level to a low level, and the first sampling transistor 712ₚ is brought into an OFF state, so that sampling of the reset signal P in the first capacitive element 711ₚ is confirmed.

Next, at time t₃₃, the control signal p_writeen transitions from a high level to a low level, and the first write transistor 713ₚ is brought into an OFF state. At the same time, the control signal p_read transitions from a low level to a high level, and the first read transistor 714ₚ is brought into an ON state.

At the same time, at time t₃₃, the control signal rst transitions from a low level to a high level, and the reset transistor 704 is brought into an ON state, so that an operation of resetting the potential of the signal read path L including the first read transistor 714ₚ to the predetermined reference potential V_{ref} is performed. By this reset operation, a history of the previous read operation can be erased.

Next, at time t₃₄, the control signal rst transitions from a high level to a low level, and the reset transistor 704 is brought into an OFF state. Thereafter, at time t₃₅, the control signal p_spl transitions from a low level to a high level, and the first sampling transistor 712ₚ is brought into an ON state. As a result, a read operation of the reset signal P written in the first capacitive element 711ₚ by the first read transistor 714ₚ is performed. In parallel with the read operation of the reset signal P, analog-digital conversion (ADC) processing is executed.

At the same time, at time t₃₅, the control signal d_writeen and the control signal d_spl transition from a low level to a high level, so that the second write transistor 713_{d} and the second sampling transistor 712_{d} are brought into the ON state, and the write operation of the data signal D into the second capacitive element 711_{d} is performed.

At time t₃₆, the control signal d_spl transitions from a high level to a low level, and the second sampling transistor 712_{d} is brought into an OFF state, so that sampling of the data signal D in the second capacitive element 711_{d} is confirmed.

Next, at time t₃₇, the control signal d_writeen transitions from a high level to a low level, and the second write transistor 713_{d} is brought into an OFF state. At the same time, the control signal d_read transitions from a low level to a high level, and the second read transistor 714_{d} is brought into an ON state.

At the same time, at time t₃₇, the control signal rst transitions from a low level to a high level, and the reset transistor 704 is brought into an ON state, so that an operation of resetting the potential of the signal read path L including the second read transistor 714_{d} to the predetermined reference potential V_{ref} is performed. By this reset operation, a history of the previous read operation can be erased.

Next, at time t₃₈, the control signal rst transitions from a high level to a low level, and the reset transistor 704 is brought into an OFF state. Thereafter, at time t₃₉, the control signal d_spl transitions from a low level to a high level, and the second sampling transistor 712_{d} is brought into an ON state. As a result, a read operation of the data signal D written in the second capacitive element 711_{d} by the second read transistor 714_{d} is performed. In parallel with the read operation of the data signal D, analog-digital conversion processing is executed.

As described above, in the imaging element 10 including the sample-and-hold circuit 70 according to the embodiment of the present technology, in Circuit operation example 1, P-phase writing (sampling) and reading and D-phase writing (sampling) and reading are pipelined, and signal reading from the pixel 20 and analog-digital conversion are processed in parallel. As a result, it is possible to substantially speed up the pixel signal read operation including the analog-digital conversion processing.

### (Consideration of Sampling Error)

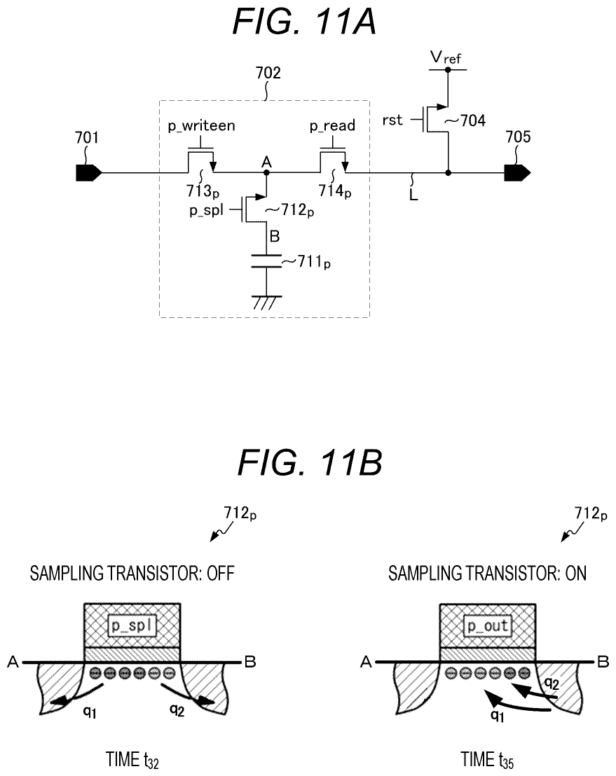

Here, a sampling error in the sample-and-hold circuit 70 according to the embodiment of the present technology will be considered with reference to a and b in FIG. 11. In a of FIG. 11, the P-phase circuit 702 in a of FIG. 9 is taken out and illustrated for convenience of description, but things similar to those in the P-phase circuit 702 apply to the D-phase circuit 703.

In a timing chart of FIG. 10, when the first sampling transistor 712ₚ is brought into an OFF state at time t₃₂, as illustrated in b of FIG. 11, a charge q₁ of about half of channel charges (q₁+q₂) of the first sampling transistor 712ₚ is distributed to a node A, and a charge q₂ of the remaining about half is distributed to a node B. The former charge q₁ is erased in a path from the node A to the input terminal 701. The latter charge q₂ becomes a charge of a sampling error.

When the first sampling transistor 712ₚ is brought into an ON state at time t₃₅, as illustrated in b of FIG. 11, the charges (q₁+q₂) forming a channel of the first sampling transistor 712ₚ are supplied from the node B. The charge q₂ is a charge of a sampling error generated at time t₃₂ and having just returned to the channel of the first sampling transistor 712ₚ again, and thus the charge q₁ affects the sampling error at the time of signal reading. Here, assuming that a capacitance value of the first capacitive element 711ₚ is C, a sampling error voltage V is provided as V=q₁/C.

As described above, in the sample-and-hold circuit 70 according to the embodiment of the present technology, only the charge q₁ which is about half of the channel charges (q₁+q₂) of the first and second sampling transistors 712ₚ and 712_{d} affects the sampling error at the end. The transistors other than the first and second sampling transistors 712ₚ and 712_{d} do not affect the sampling error.

For the first and second write transistors 713ₚ and 713_{d}, charge injection occurring at the node A when the first and second write transistors 713ₚ and 713_{d} are brought into an OFF state at time t₃₃ is erased by the reset operation from time t₃₃ to time t₃₄. Therefore, the first and second write transistors 713ₚ and 713_{d} do not affect the sampling error.

For the first and second read transistors 714ₚ and 714_{d}, signal reading is performed after initialization in the ON state of the first and second read transistors 714ₚ and 714_{d}. Therefore, the first and second read transistors 714ₚ and 714_{d} do not affect the sampling error.

When the reset transistor 704 transitions from the ON state to the OFF state at time t₃₄, charge injection occurs at the node A and the output terminal 705, but can be removed by the CDS processing executed in the analog-digital conversion unit 15 in a subsequent stage. Therefore, the reset transistor 704 does not affect the sampling error.

As is apparent from the consideration of the sampling error described above, according to the sample-and-hold circuit 70 according to the embodiment of the present technology, it is possible to suppress the sampling error due to variations in charge injection. A circuit configuration is a simple circuit configuration that can be configured with seven transistors, as compared with the circuit configuration that requires ten transistors of the sample-and-hold circuit 70B according to Reference Example 2. That is, according to the sample-and-hold circuit 70 according to the embodiment of the present technology, the expected object can be achieved with a simpler circuit configuration.

### (About Configuration of Transistor)

In the sample-and-hold circuit 70 according to the above-described embodiment, a configuration has been exemplified in which NMOS transistors are used as the first and second sampling transistors 712ₚ and 712_{d}, the first and second write transistors 713ₚ and 713_{d}, the first and second read transistors 714ₚ and 714_{d}, and the reset transistor 704, but the present disclosure is not limited to the NMOS transistors. That is, a PMOS transistor or a CMOS transistor can be used.

When a potential of an input signal is low, it is preferable to use an NMOS transistor. Conversely, when a potential of an input signal is high, it is preferable to use a PMOS transistor. In a case where an input signal has a wide range from low to high, it is preferable to use a CMOS transistor. However, in the case of the CMOS transistor, since the number of elements of the transistor constituting the circuit is doubled, variations in charge injection are generally larger than those in the case of a single NMOS transistor or PMOS transistor.

In the sample-and-hold circuit 70 according to the embodiment of the present technology, only the first and second sampling transistors 712ₚ and 712_{d} affect the sampling error. By configuring the first and second sampling transistors 712ₚ and 712_{d} with transistors having a relatively small size, sampling errors can be further suppressed. Furthermore, by configuring transistors other than the first and second sampling transistors 712ₚ and 712_{d} with transistors having a relatively large size, a higher speed operation can be achieved.

### Example 3

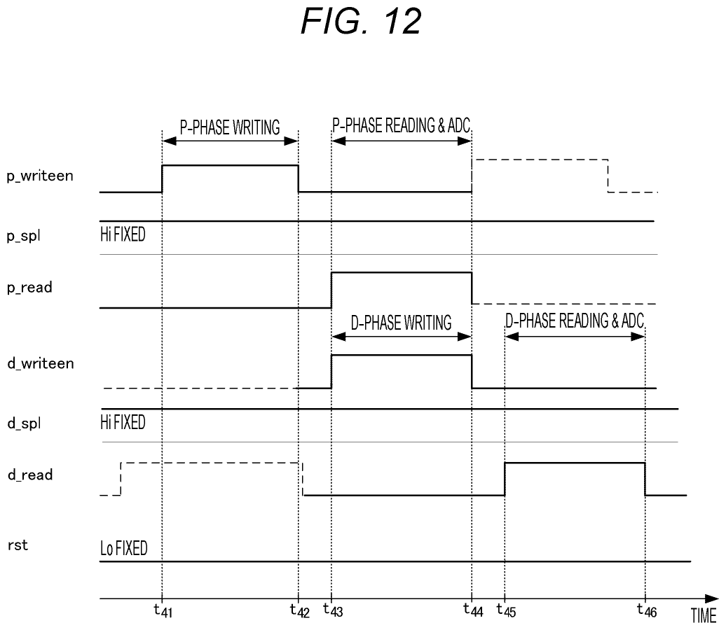

Example 3 is an example (part 2) of a circuit operation of the sample-and-hold circuit according to the embodiment of the present technology. FIG. 12 is a timing chart illustrating Circuit operation example 2 of the sample-and-hold circuit according to the embodiment of the present technology.

The timing chart of FIG. 12 illustrates a timing relationship between the control signal p_writeen, the control signal p_spl, and the control signal p_read for P-phase, the control signal d_writeen, the control signal d_spl, and the control signal d_read for D-phase, and the control signal rst. In Circuit operation example 2, the control signal p_spl and the control signal d_spl are always fixed at a high level (Hi), and the control signal rst is always fixed at a low level (Lo).

At time t₄₁, when the control signal p_writeen transitions from a low level to a high level, the first write transistor 713ₚ is brought into an ON state, and a write operation of the reset signal P into the first capacitive element 711ₚ is performed through the first sampling transistor 712ₚ that is always in the ON state.

Next, at time t₄₂, the control signal p_writeen transitions from a high level to a low level, and the first write transistor 713ₚ is brought into an OFF state. Thereafter, at time t₄₃, the control signal p_read transitions from a low level to a high level, and the first read transistor 714ₚ is brought into an ON state. As a result, read operation of the reset signal P written in the first capacitive element 711ₚ is performed by the first read transistor 714ₚ through the first sampling transistor 712ₚ that is always in the ON state. In parallel with the read operation of the reset signal P, analog-digital conversion processing is executed.

At the same time, at time t₄₃, when the control signal d_writeen transitions from a low level to a high level, the second write transistor 713_{d} is brought into an ON state, and a write operation of the data signal D into the second capacitive element 711_{d} is performed through the second sampling transistor 712_{d} that is always in the ON state.

Next, at time t₄₄, the control signal d_writeen transitions from a high level to a low level, and the second write transistor 713_{d} is brought into an OFF state. Thereafter, at time t₄₅, the control signal d_read transitions from a low level to a high level, and the second read transistor 714_{d} is brought into an ON state. As a result, read operation of the data signal D written in the second capacitive element 711_{d} is performed by the second read transistor 714_{d} through the second sampling transistor 712_{d} that is always in the ON state. In parallel with the read operation of the data signal D, analog-digital conversion processing is executed.

As described above, in the imaging element 10 including the sample-and-hold circuit 70 according to the embodiment of the present technology, in Circuit operation example 2, P-phase writing and reading and D-phase writing (sampling) and reading are pipelined similarly to the case of Circuit operation example 1, and signal reading from the pixel 20 and analog-digital conversion are processed in parallel. As a result, it is possible to substantially speed up the pixel signal read operation including the analog-digital conversion processing. Furthermore, in Circuit operation example 2, since the control signal p_spl and the control signal d_spl are always fixed to the high level (Hi) and the control signal rst is always fixed to the low level (Lo), time overhead between the write operation and the read operation of the reset signal P and the data signal D can be minimized, and thus, the pixel signal read operation can be further speeded up.

### Example 4

Example 4 is an example of a drive mode of the imaging element 10 including the sample-and-hold circuit 70 according to the embodiment of the present technology.

The imaging element 10 including the sample-and-hold circuit 70 according to the embodiment of the present technology has two drive modes of a low-error drive mode and a high-speed drive mode, as drive modes. The low-error drive mode is a drive mode suitable for use in still-image capturing and the like. In the low-error drive mode, a circuit operation based on Circuit operation example 1 according to Example 2 is performed on the sample-and-hold circuit 70. The high-speed drive mode is a drive mode suitable for use in moving-image capturing and the like. In the high-speed drive mode, a circuit operation based on Circuit operation example 2 according to Example 3 is performed on the sample-and-hold circuit 70.

As described above, in the imaging element 10 having the two drive modes of the low-error drive mode and the high-speed drive mode, even in the sample-and-hold circuit 70 having the same circuit configuration, it is possible to select whether to emphasize a characteristic or an operation speed by using a driving method of the sample-and-hold circuit 70.

### Example 5

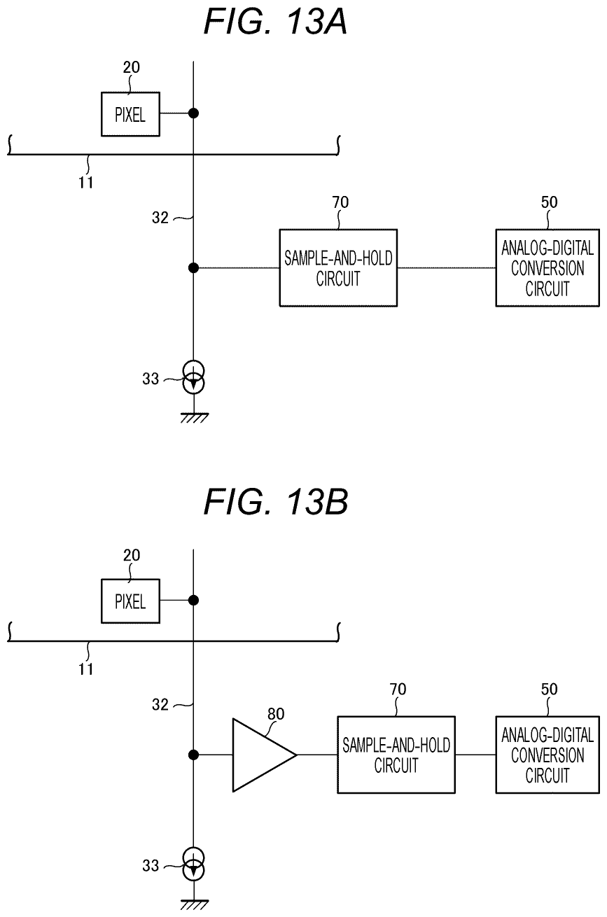

Example 5 is an example of an arrangement of the sample-and-hold circuit 70 according to the embodiment of the present technology. FIG. 13 is a block diagram illustrating an arrangement example of the sample-and-hold circuit 70 according to the embodiment of the present technology. Here, Arrangement example 1 and Arrangement example 2 as the arrangement example of the sample-and-hold circuit 70 are illustrated.

In FIG. 13, a illustrates Arrangement example 1 of the sample-and-hold circuit 70. Arrangement example 1 has a configuration in which an input end of the sample-and-hold circuit 70 is electrically connected directly to the signal line 32. That is, in Arrangement example 1, the reset signal P and the data signal D output from the pixel 20 through the signal line 32 are directly sampled by the sample-and-hold circuit 70.

In FIG. 13, b illustrates Arrangement example 2 of the sample-and-hold circuit 70. Arrangement example 2 has a configuration in which an input end of the sample-and-hold circuit 70 is electrically connected to the signal line 32 via an amplifier 80. That is, in Arrangement example 2, the amplifier 80 disposed between the signal line 32 and the sample-and-hold circuit 70 is provided, and the reset signal P and the data signal D provided from the signal line 32 are once amplified by the amplifier 80 and then sampled by the sample-and-hold circuit 70. According to Arrangement example 2, it is possible to reduce input conversion of noise after the sample-and-hold circuit 70.

### Example 6

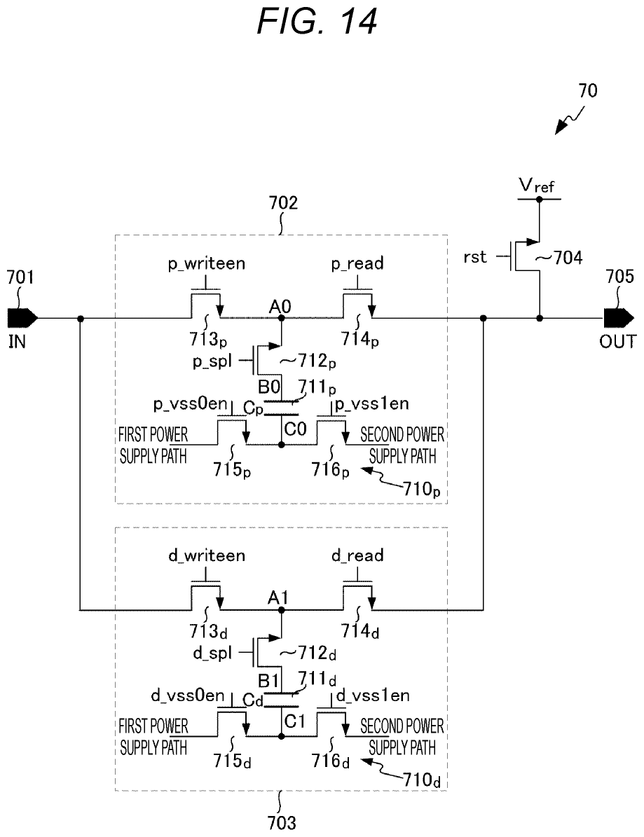

Example 6 is an example in which a power supply path of a low-potential-side power supply of a capacitive element is switched, in the sample-and-hold circuit 70 according to the embodiment of the present technology. FIG. 14 is a circuit diagram for explaining power supply switching of the sample-and-hold circuit 70 according to the embodiment of the present technology.

As illustrated in FIG. 14, the sample-and-hold circuit 70 according to Example 6 includes a power supply path switching unit 710ₚ in the P-phase circuit 702 and a power supply path switching unit 710_{d} in the D-phase circuit 703.

In the P-phase circuit 702, the power supply path switching unit 710ₚ includes a transistor 715ₚ and a transistor 716ₚ connected between a terminal on a power supply side (low potential side terminal) of the first capacitive element 711ₚ and a first power supply path and a second power supply path. The first power supply path and the second power supply path are electrically separated power supply paths. By entering an ON state in response to a control signal p_vss0en applied to a gate electrode at the time of signal writing on the first capacitive element 711ₚ, the transistor 715ₚ electrically connects the terminal on the power supply side of the first capacitive element 711ₚ to the first power supply path. By entering an ON state in response to a control signal p_vss1en applied to a gate electrode at the time of signal reading from the first capacitive element 711ₚ, the transistor 716ₚ electrically connects the terminal on the power supply side of the first capacitive element 711ₚ to the second power supply path.

In the D-phase circuit 703, the power supply path switching unit 710_{d} includes a transistor 715_{d} and a transistor 716_{d} connected between a terminal on a power supply side (low potential side terminal) of the second capacitive element 711_{d} and a first power supply path and a second power supply path. The first power supply path and the second power supply path are electrically separated power supply paths. By entering an ON state in response to a control signal d_vss0en applied to a gate electrode at the time of signal writing on the second capacitive element 711_{d}, the transistor 715_{d} electrically connects the terminal on the power supply side of the second capacitive element 711_{d} to the first power supply path. By entering an ON state in response to a control signal d_vss1en applied to a gate electrode at the time of signal reading from the second capacitive element 711_{d}, the transistor 716_{d} electrically connects the terminal on the power supply side of the second capacitive element 711_{d} to the second power supply path.

In the sample-and-hold circuit 70 according to the embodiment of the present technology, in a case of executing the pipeline processing described above, a large current may be generated in charge and discharge to the first capacitive element 711ₚ and the second capacitive element 711_{d} at the time of writing. An IR drop of the low-potential-side power supply (for example, ground) due to the write operation causes crosstalk that fluctuates signals read in parallel.

On the other hand, in the sample-and-hold circuit 70 according to Example 5, the power supply path of the low-potential-side power supply is switched to the electrically separated first power supply path and second power supply path at the time of signal writing and signal reading on the first capacitive element 711ₚ and the second capacitive element 711_{d}, so that the crosstalk as described above can be reduced.

### Example 7

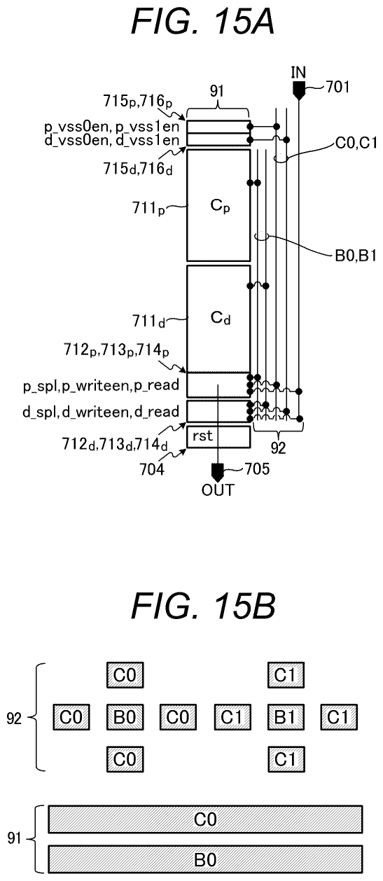

Example 7 is an example of a wiring structure of the sample-and-hold circuit 70 according to the embodiment of the present technology. FIG. 15 is a diagram for explaining a wiring structure of the sample-and-hold circuit 70 according to the embodiment of the present technology.

In the sample-and-hold circuit 70 having the circuit configuration illustrated in FIG. 14 of Example 6, a wiring line between the first capacitive element 711ₚ and the first sampling transistor 712ₚ is defined as B0, and a wiring line between the second capacitive element 711_{d} and the second sampling transistor 712_{d} is defined as B1. Furthermore, a wiring line between the first capacitive element 711ₚ and the transistors 715ₚ and 716ₚ is defined as C0, and a wiring line between the second capacitive element 711_{d} and the transistors 715_{d} and 716_{d} is defined as C1.

In FIG. 15, a is a conceptual diagram illustrating an element layer 91 including the first and second capacitive elements 711ₚ and 711_{d} and various transistors, and a wiring layer 92 including the wiring lines B0, B1, C0, and C1. Further, b of FIG. 15 is a cross-sectional view of a portion of the first capacitive element 711ₚ. Note that, in the conceptual diagram of a of FIG. 15, the element layer 91 and the wiring layer 92 are illustrated side by side for convenience of description, but actually, as illustrated in b of FIG. 15, the element layer 91 and the wiring layer 92 are in a layered relationship.

As is apparent from b of FIG. 15, the wiring structure according to Example 7 has a wiring structure in which the wiring lines B0 and B1 are shielded by the wiring lines C0 and C1. In this manner, by shielding the wiring lines B0 and B1 with the wiring lines C0 and C1, resistance to noise and crosstalk can be enhanced.

Furthermore, in the wiring structure according to Example 7, wiring lengths of the wiring lines B0 and B1 are desirably as equal as possible. Here, “equal length” means to include not only a case where lengths are strictly equal but also a case where lengths are substantially equal, and existence of various variations caused by design or manufacturing is allowed. By setting the wiring lengths of the wiring lines B0 and B1 to be the same length as much as possible, a sampling error and disturbance of P phase and D phase can be aligned and removed by the CDS processing executed in the analog-digital conversion unit 15 in a subsequent stage.

### <Modifications>

Note that the embodiment described above indicates examples for embodying the present technology, and the respective matters in the embodiment and the respective matters specifying the invention in the claims have correspondence relationships. Similarly, the matters specifying the invention in the claims and the matters with the same names in the embodiment of the present technology have correspondence relationships, respectively. However, the present technology is not limited to the embodiment, and can be embodied by applying various modifications to the embodiment without departing from the scope of the present technology.

### <Application Example to Electronic Device>

The imaging element according to the embodiment of the present technology described above is applicable to various electronic devices having an imaging function, such as an imaging device such as a digital still camera or a video camera, a mobile terminal device having an imaging function such as a mobile phone, and a copier using an imaging device in an image reading unit.

### [Example of Imaging Device]

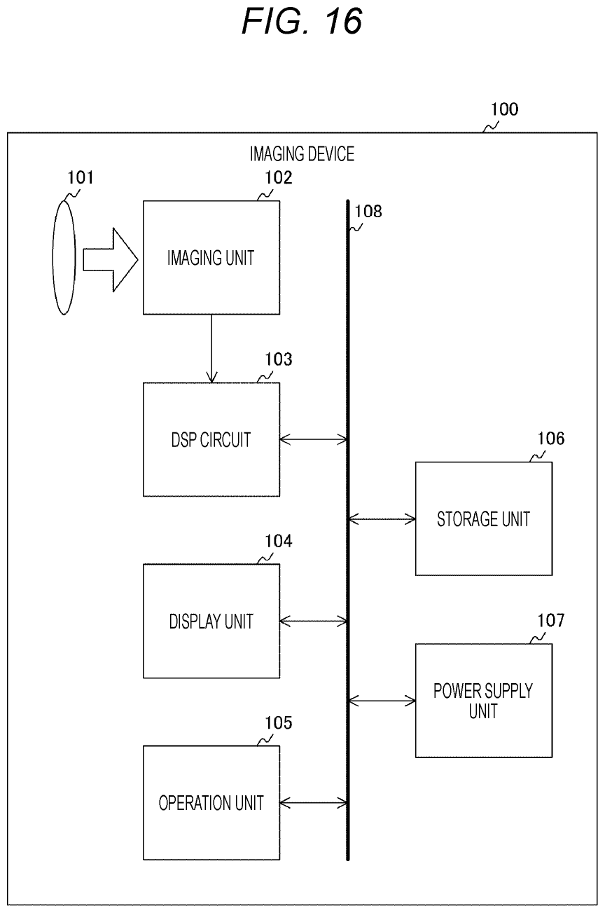

FIG. 16 is a block diagram illustrating a configuration example of an imaging device which is an example of an electronic device to which the present technology is applied.

An imaging device 100 according to the present application example is a device for imaging a subject, and includes an imaging optical system 101 including a lens group and the like, an imaging unit 102, a digital signal processor (DSP) circuit 103, a display unit 104, an operation unit 105, a storage unit 106, and a power supply unit 107. These are connected to one another by a bus 108. As the imaging device 100, for example, in addition to a digital camera such as a digital still camera, a smartphone and a personal computer having an imaging function, an in-vehicle camera, and the like are assumed.

The imaging unit 102 generates pixel data by photoelectric conversion. As the imaging unit 102, the imaging element in the embodiment of the present technology can be used. Light from a subject is condensed and guided to a light receiving surface of the imaging unit 102 by the imaging optical system 101 disposed on an incident light side. The imaging unit 102 supplies pixel data generated by photoelectric conversion to a DSP circuit 103 in a subsequent stage.

The DSP circuit 103 executes predetermined signal processing on the pixel data from the imaging unit 102. The display unit 104 displays the pixel data. As the display unit 104, for example, a liquid crystal panel or an organic electro luminescence (EL) panel is assumed. The operation unit 105 generates an operation signal according to a user's operation. The storage unit 106 stores various types of data such as the pixel data. The power supply unit 107 supplies power to the imaging unit 102, the DSP circuit 103, the display unit 104, and the like.

In the imaging device 100 having the above-described configuration, the imaging element 10 including the sample-and-hold circuit 70 according to the embodiment of the present technology can be mounted as the imaging unit 102. According to the imaging element 10, it is possible to suppress fixed pattern noise of a pixel column by reducing variations in charge injection due to the switching operation at the time of sampling and holding. Therefore, vertical streaks caused by the fixed pattern noise of the pixel column do not appear on a captured image, so that a captured image with high image quality can be obtained.

### <Application Example of Embodiment of Present Technology>

The above embodiment of the present technology can be applied to various technologies as exemplified below.

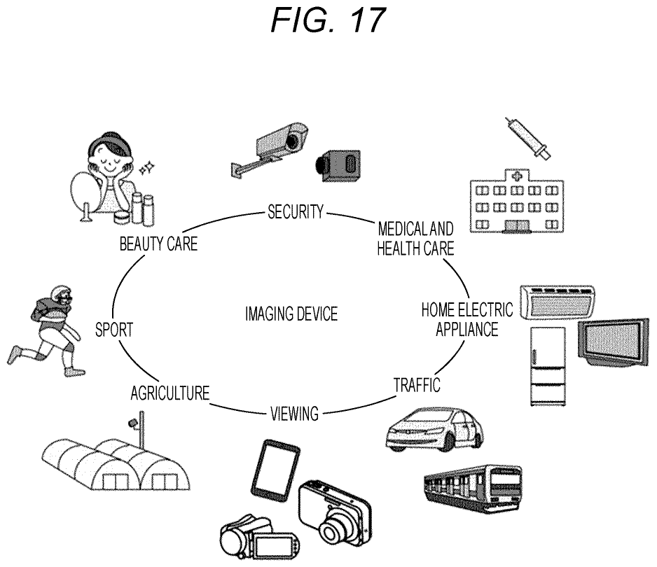

FIG. 17 illustrates an example of fields to which the embodiment of the present technology is applied.

The imaging device according to the embodiment of the present technology can be, for example, used as a device that captures an image to be used for viewing, such as a digital camera or a portable device having a camera function.

Furthermore, this imaging device can be used as a device for traffic purpose such as an in-vehicle sensor which takes an image of surroundings, interior, or the like of an automobile, a surveillance camera for monitoring traveling vehicles and roads, and a ranging sensor which measures a distance between vehicles and the like for safe driving such as automatic stop, recognition of a driver's condition and the like.

Furthermore, this imaging device can be used as a device used for home electric appliances such as a television, a refrigerator, and an air conditioner in order to capture an image of a gesture of a user and perform device operation according to the gesture.

Furthermore, this imaging device can be used as a device for medical and health care use such as an endoscope and a device that performs angiography by receiving infrared light.

Furthermore, this imaging device can be used as a device for security use such as a security monitoring camera and an individual authentication camera.

Furthermore, this imaging device can be used as a device used for beauty care, such as a skin measuring instrument for imaging skin, and a microscope for imaging the scalp.

Furthermore, this imaging device can be used as a device used for sport, such as an action camera or a wearable camera for sports applications or the like.

Furthermore, this imaging device can be used as a device used for agriculture, such as a camera for monitoring a condition of a field or crop.

### <Application Example to Mobile Body>

The technology according to the present disclosure (the present technology) can be applied to various products. For example, the technology according to the present disclosure may be implemented in the form of a device to be mounted on a mobile body of any kind, such as an automobile, an electric vehicle, a hybrid electric vehicle, a motorcycle, a bicycle, a personal mobility, an airplane, a drone, a vessel, or a robot.

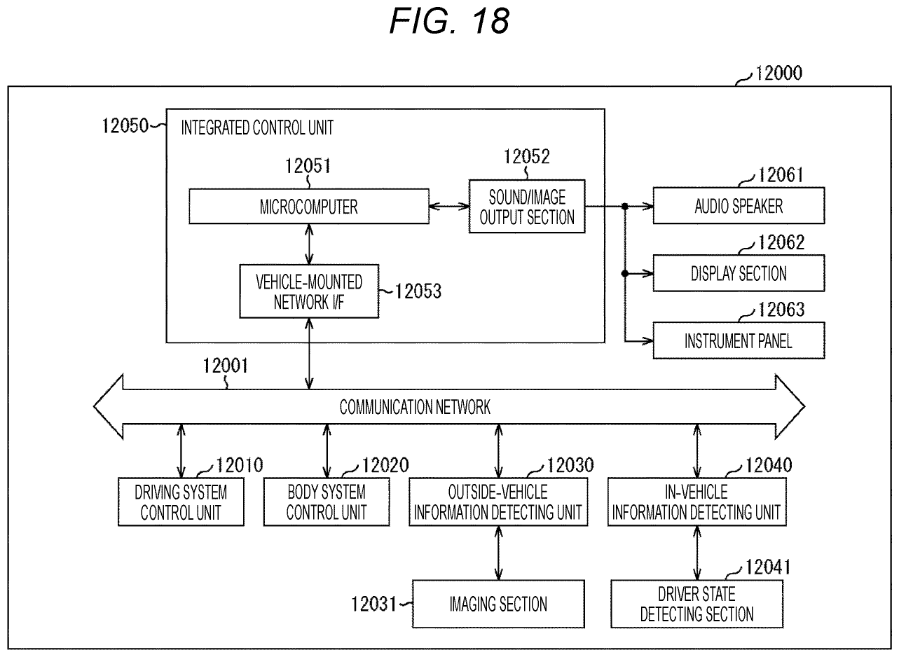

FIG. 18 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 18, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020, on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 18, an audio speaker 12061, a display section 12062, and an instrument panel 12063 are exemplified as the output devices. The display section 12062 may, for example, include at least one of an on-board display and a head-up display.

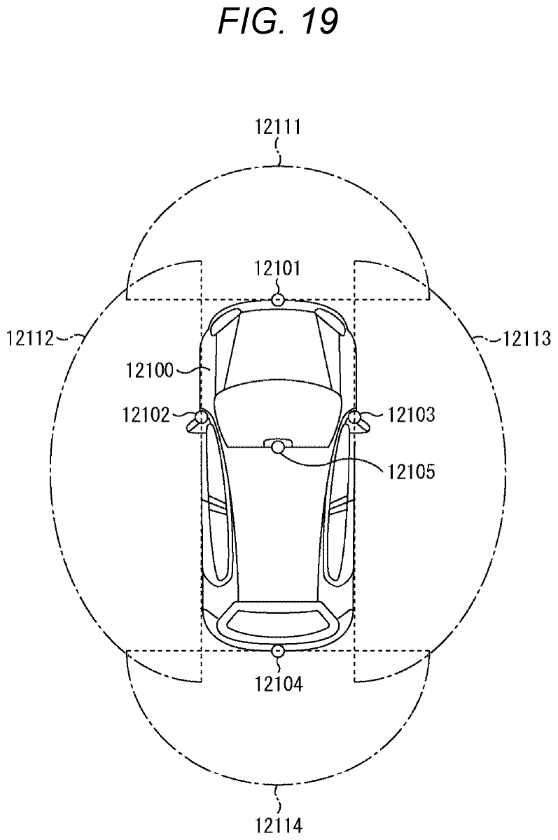

FIG. 19 is a view illustrating an example of an installation position of the imaging section 12031.

In FIG. 19, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 19 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure is applicable to the imaging section 12031, for example, among the configurations described above. Then, in a case where the imaging section 12031 or the like includes a sample-and-hold unit at a preceding stage of the column-parallel type analog-digital conversion unit, the technology according to the present disclosure can be applied to each sample-and-hold circuit constituting the sample-and-hold unit. As a result, it is possible to suppress fixed pattern noise of a pixel column by reducing variations in charge injection due to the switching operation at the time of sampling and holding. Therefore, vertical streaks caused by the fixed pattern noise of the pixel column do not appear on a captured image, so that a captured image with high image quality can be obtained. Note that the effects described herein are merely illustrative and not limiting, and other effects may also be present.

<Configuration that Present Technology can Employ>

Note that the present technology may also have the following configurations.

(1) An imaging element including:
a pixel array unit in which a plurality of pixels each including a photoelectric conversion unit is arranged in a matrix;
and a sample-and-hold circuit that is provided corresponding to a pixel column of the pixel array unit and samples and holds a pixel signal including a reset signal and a data signal output from the pixels through a signal line, in which
the sample-and-hold circuit includes:
a first capacitive element;
a first sampling transistor connected in series to the first capacitive element;
a first write transistor that is connected between an input terminal configured to receive the reset signal and the first sampling transistor, and writes the reset signal input from the input terminal into the first capacitive element, through the first sampling transistor;
a first read transistor that is connected between the first sampling transistor and an output terminal, and reads the reset signal written in the first capacitive element, through the first sampling transistor;
a second capacitive element;
a second sampling transistor connected in series to the second capacitive element;
a second write transistor that is connected between an input terminal configured to receive the data signal and the second sampling transistor, and writes the data signal input from the input terminal into the second capacitive element, through the second sampling transistor;
a second read transistor that is connected between the second sampling transistor and the output terminal, and reads the data signal written in the second capacitive element, through the second sampling transistor; and
a reset transistor that is connected between the output terminal and a node of a predetermined reference potential.

(2) The imaging element according to (1), in which
the first sampling transistor and the second sampling transistor each include a transistor having a relatively small size.

(3) The imaging element according to (2), in which
each of the first write transistor, the first read transistor, the second write transistor, the second read transistor, and the reset transistor includes a transistor having a relatively large size.

(4) The imaging element according to any one of (1) to (3), in which
the first write transistor and the first sampling transistor are brought into an ON state and the reset signal is written into the first capacitive element, then the first sampling transistor is brought into an OFF state, then the first read transistor and the reset transistor are brought into an ON state and a signal read path is initialized, and then the first sampling transistor is brought into an ON state and the reset signal written in the first capacitive element is read through the signal read path, and
thereafter, the second write transistor and the second sampling transistor are brought into an ON state and the data signal is written into the second capacitive element, then the second sampling transistor is brought into an OFF state, then the second read transistor and the reset transistor are brought into an ON state and the signal read path is initialized, and then the second sampling transistor is brought into an ON state and the data signal written in the second capacitive element is read through the signal read path.

(5) The imaging element according to any one of (1) to (3), in which
in a state in which the first sampling transistor and the second sampling transistor are always in an ON state and the reset transistor is always in an OFF state,
the first write transistor is brought into an ON state and the reset signal is written into the first capacitive element, and then the first read transistor is brought into an ON state and the reset signal written in the first capacitive element is read, and
thereafter, the second write transistor is brought into an ON state and the data signal is written into the second capacitive element, and then the second read transistor is brought into an ON state and the data signal written in the second capacitive element is read.

(6) The imaging element according to any one of (1) to (5), further including
an amplifier disposed between the signal line and the sample-and-hold circuit.

(7) The imaging element according to any one of (1) to (3), in which
a low-error drive mode and a high-speed drive mode are provided,
in the low-error drive mode,
the first write transistor and the first sampling transistor are brought into an ON state and the reset signal is written into the first capacitive element, then the first sampling transistor is brought into an OFF state, then the first read transistor and the reset transistor are brought into an ON state and a signal read path is initialized, and then the first sampling transistor is brought into an ON state and the reset signal written in the first capacitive element is read through the signal read path, and
thereafter, the second write transistor and the second sampling transistor are brought into an ON state and the data signal is written into the second capacitive element, then the second sampling transistor is brought into an OFF state, then the second read transistor and the reset transistor are brought into an ON state and the signal read path is initialized, and then the second sampling transistor is brought into an ON state and the data signal written in the second capacitive element is read through the signal read path, and
in the high-speed drive mode,
in a state in which the first sampling transistor and the second sampling transistor are always in an ON state and the reset transistor is always in an OFF state,
the first write transistor is brought into an ON state and the reset signal is written into the first capacitive element, and then the first read transistor is brought into an ON state and the reset signal written in the first capacitive element is read, and
thereafter, the second write transistor is brought into an ON state and the data signal is written into the second capacitive element, and then the second read transistor is brought into an ON state and the data signal written in the second capacitive element is read.

(8) The imaging element according to any one of (1) to (3), in which
the sample-and-hold circuit includes a power supply path switching unit that connects a terminal on a power supply side of each of the first capacitive element and the second capacitive element to different power supply paths electrically separated, at a time of signal writing into the first capacitive element and the second capacitive element and at a time of signal reading from the first capacitive element and the second capacitive element.

(9) The imaging element according to (8), in which
the sample-and-hold circuit has a wiring structure in which a wiring line between the first capacitive element and the first sampling transistor and a wiring line between the second capacitive element and the second sampling transistor are shielded by a wiring line between the first capacitive element and the power supply path switching unit and a wiring line between the second capacitive element and the power supply path switching unit.

(10) The imaging element according to (9), in which
in the wiring structure, a wiring length of a wiring line between the first capacitive element and the first sampling transistor is equal to a wiring length of a wiring line between the second capacitive element and the second sampling transistor.

(11) An electronic device including an imaging element, the imaging element including:
a pixel array unit in which a plurality of pixels each including a photoelectric conversion unit is arranged in a matrix;
and a sample-and-hold circuit that is provided corresponding to a pixel column of the pixel array unit and samples and holds a pixel signal including a reset signal and a data signal output from the pixels through a signal line, in which
the sample-and-hold circuit includes:
a first capacitive element;
a first sampling transistor connected in series to the first capacitive element;
a first write transistor that is connected between an input terminal configured to receive the reset signal and the first sampling transistor, and writes the reset signal input from the input terminal into the first capacitive element, through the first sampling transistor;
a first read transistor that is connected between the first sampling transistor and an output terminal, and reads the reset signal written in the first capacitive element, through the first sampling transistor;
a second capacitive element;
a second sampling transistor connected in series to the second capacitive element;
a second write transistor that is connected between an input terminal configured to receive the data signal and the second sampling transistor, and writes the data signal input from the input terminal into the second capacitive element, through the second sampling transistor;
a second read transistor that is connected between the second sampling transistor and the output terminal, and reads the data signal written in the second capacitive element, through the second sampling transistor; and
a reset transistor connected between the output terminal and a node of a predetermined reference potential.

### REFERENCE SIGNS LIST

10 Imaging element of present technology
11 Pixel array unit
12 Vertical scanning unit
13 Load MOS unit
14 Sample-and-hold unit
15 Analog-digital conversion unit
16 Memory unit
17 Data processing unit
18 Output unit
19 Timing control unit
20 Pixel (pixel circuit)
21 Photodiode (photoelectric conversion unit)
22 Charge transfer unit
23 Charge-voltage conversion unit
24 Charge resetting unit
25 Signal amplification unit
26 Pixel selection unit
31 Pixel control line
32 Signal line
40 Reference signal generation unit
50 Single-slope analog-digital conversion circuit
70 Sample-and-hold circuit according to embodiment of present technology
70A Sample-and-hold circuit according to Reference Example 1
70B Sample-and-hold circuit according to Reference Example 2
80 Amplifier
91 Element layer
92 Wiring layer

What is claimed is:

1. An imaging element comprising:
a pixel array unit in which a plurality of pixels each including a photoelectric conversion unit is arranged in a matrix;
and a sample-and-hold circuit that is provided corresponding to a pixel column of the pixel array unit and samples and holds a pixel signal including a reset signal and a data signal output from the pixels through a signal line, wherein
the sample-and-hold circuit includes:
a first capacitive element;
a first sampling transistor connected in series to the first capacitive element;
a first write transistor that is connected between an input terminal configured to receive the reset signal and the first sampling transistor, and writes the reset signal input from the input terminal into the first capacitive element, through the first sampling transistor;
a first read transistor that is connected between the first sampling transistor and an output terminal, and reads the reset signal written in the first capacitive element, through the first sampling transistor;
a second capacitive element;
a second sampling transistor connected in series to the second capacitive element;
a second write transistor that is connected between an input terminal configured to receive the data signal and the second sampling transistor, and writes the data signal input from the input terminal into the second capacitive element, through the second sampling transistor;
a second read transistor that is connected between the second sampling transistor and the output terminal, and reads the data signal written in the second capacitive element, through the second sampling transistor; and
a reset transistor that is connected between the output terminal and a node of a predetermined reference potential.

2. The imaging element according to claim 1, wherein
the first sampling transistor and the second sampling transistor each include a transistor having a relatively small size.

3. The imaging element according to claim 2, wherein
each of the first write transistor, the first read transistor, the second write transistor, the second read transistor, and the reset transistor includes a transistor having a relatively large size.

4. The imaging element according to claim 1, wherein
the first write transistor and the first sampling transistor are brought into an ON state and the reset signal is written into the first capacitive element, then the first sampling transistor is brought into an OFF state, then the first read transistor and the reset transistor are brought into an ON state and a signal read path is initialized, and then the first sampling transistor is brought into an ON state and the reset signal written in the first capacitive element is read through the signal read path, and
thereafter, the second write transistor and the second sampling transistor are brought into an ON state and the data signal is written into the second capacitive element, then the second sampling transistor is brought into an OFF state, then the second read transistor and the reset transistor are brought into an ON state and the signal read path is initialized, and then the second sampling transistor is brought into an ON state and the data signal written in the second capacitive element is read through the signal read path.

5. The imaging element according to claim 1, wherein
in a state in which the first sampling transistor and the second sampling transistor are always in an ON state and the reset transistor is always in an OFF state,
the first write transistor is brought into an ON state and the reset signal is written into the first capacitive element, and then the first read transistor is brought into an ON state and the reset signal written in the first capacitive element is read, and
thereafter, the second write transistor is brought into an ON state and the data signal is written into the second capacitive element, and then the second read transistor is brought into an ON state and the data signal written in the second capacitive element is read.

6. The imaging element according to claim 1, further comprising
an amplifier disposed between the signal line and the sample-and-hold circuit.

7. The imaging element according to claim 1, wherein
a low-error drive mode and a high-speed drive mode are provided,
in the low-error drive mode,
the first write transistor and the first sampling transistor are brought into an ON state and the reset signal is written into the first capacitive element, then the first sampling transistor is brought into an OFF state, then the first read transistor and the reset transistor are brought into an ON state and a signal read path is initialized, and then the first sampling transistor is brought into an ON state and the reset signal written in the first capacitive element is read through the signal read path, and
thereafter, the second write transistor and the second sampling transistor are brought into an ON state and the data signal is written into the second capacitive element, then the second sampling transistor is brought into an OFF state, then the second read transistor and the reset transistor are brought into an ON state and the signal read path is initialized, and then the second sampling transistor is brought into an ON state and the data signal written in the second capacitive element is read through the signal read path, and
in the high-speed drive mode,
in a state in which the first sampling transistor and the second sampling transistor are always in an ON state and the reset transistor is always in an OFF state,
the first write transistor is brought into an ON state and the reset signal is written into the first capacitive element, and then the first read transistor is brought into an ON state and the reset signal written in the first capacitive element is read, and
thereafter, the second write transistor is brought into an ON state and the data signal is written into the second capacitive element, and then the second read transistor is brought into an ON state and the data signal written in the second capacitive element is read.

8. The imaging element according to claim 1, wherein
the sample-and-hold circuit includes a power supply path switching unit that connects a terminal on a power supply side of each of the first capacitive element and the second capacitive element to different power supply paths electrically separated, at a time of signal writing into the first capacitive element and the second capacitive element and at a time of signal reading from the first capacitive element and the second capacitive element.

9. The imaging element according to claim 8, wherein
the sample-and-hold circuit has a wiring structure in which a wiring line between the first capacitive element and the first sampling transistor and a wiring line between the second capacitive element and the second sampling transistor are shielded by a wiring line between the first capacitive element and the power supply path switching unit and a wiring line between the second capacitive element and the power supply path switching unit.

10. The imaging element according to claim 9, wherein
in the wiring structure, a wiring length of a wiring line between the first capacitive element and the first sampling transistor is equal to a wiring length of a wiring line between the second capacitive element and the second sampling transistor.

11. An electronic device comprising an imaging element, the imaging element including:
a pixel array unit in which a plurality of pixels each including a photoelectric conversion unit is arranged in a matrix;
and a sample-and-hold circuit that is provided corresponding to a pixel column of the pixel array unit and samples and holds a pixel signal including a reset signal and a data signal output from the pixels through a signal line, wherein
the sample-and-hold circuit includes:
a first capacitive element;
a first sampling transistor connected in series to the first capacitive element;
a first write transistor that is connected between an input terminal configured to receive the reset signal and the first sampling transistor, and writes the reset signal input from the input terminal into the first capacitive element, through the first sampling transistor;
a first read transistor that is connected between the first sampling transistor and an output terminal, and reads the reset signal written in the first capacitive element, through the first sampling transistor;
a second capacitive element;
a second sampling transistor connected in series to the second capacitive element;
a second write transistor that is connected between an input terminal configured to receive the data signal and the second sampling transistor, and writes the data signal input from the input terminal into the second capacitive element, through the second sampling transistor;
a second read transistor that is connected between the second sampling transistor and the output terminal, and reads the data signal written in the second capacitive element, through the second sampling transistor; and
a reset transistor connected between the output terminal and a node of a predetermined reference potential.
